(19) United States
(12) Patent Application Publication
(10) Pub. No.: US 2026/0155878 A1
(43) Pub. Date: Jun. 4, 2026

(54) CSI FEEDBACK METHOD AND APPARATUS, TERMINAL, NETWORK SIDE DEVICE, AND MEDIUM

(71) Applicant: VIVO MOBILE COMMUNICATION CO., LTD., Dongguan (CN)

(72) Inventors: Hao WU, Dongguan (CN); Yang SONG, Dongguan (CN); Jiangwei YUAN, Dongguan (CN); Rakesh TAMRAKAR, Dongguan (CN); Kaili ZHENG, Dongguan (CN)

(21) Appl. No.: 19/457,107

(22) Filed: Jan. 22, 2026

Related U.S. Application Data
(63) Continuation of application No. PCT/CN2024/107219, filed on Jul. 24, 2024.

(30) Foreign Application Priority Data
Jul. 25, 2023 (CN) 202310921599.1

(51) Int. Cl. H04B 7/06; H04B 7/0456

(52) U.S. Cl. CPC H04B 7/0643; H04B 7/0456; H04B 7/0626

(57) ABSTRACT

Provided are a CSI feedback method and apparatus, a terminal, a network-side device, and a medium. The CSI feedback method includes the following steps. A terminal receives, from a network-side device, configuration information for channel state information CSI; and the terminal selects, from information associated with the configuration information, part or all of the information for CSI feedback, the CSI fed back including information related to the selected information, where a precoding matrix indicated by the CSI fed back is a product of at least two submatrices, and a dimension of at least one of the at least two submatrices is determined based on the selected information.

### CROSS-REFERENCE TO RELATED APPLICATIONS

This application is a continuation of International Patent Application No. PCT/CN2024/107219, filed on Jul. 24, 2024, which claims priority to Chinese Patent Application No. 202310921599.1, filed with the China National Intellectual Property Administration on Jul. 25, 2023 and entitled “CSI FEEDBACK METHOD AND APPARATUS, TERMINAL, NETWORK-SIDE DEVICE, AND MEDIUM”, both of which are incorporated herein by reference in their entireties.

### TECHNICAL FIELD

This application pertains to the field of communication technologies, and specifically relates to a CSI feedback method and apparatus, a terminal, a network-side device, and a medium.

### BACKGROUND

In a wireless communication system, a network-side device and a terminal generally use multiple antennas for transmission and reception to achieve a higher transmission rate. A principle of a multi-antenna technology is to use some characteristics of a channel to form multi-layer transmission that matches the characteristics of the channel. In this way, a radiation direction of a signal is targeted, and system performance can be improved without increasing a bandwidth and power. The network-side device may improve transmission efficiency and reliability by performing precoding on multiple antennas. To achieve high-performance precoding transmission, a precoding matrix needs to match the channel, which requires the terminal to feed back Channel State Information (CSI). The network-side device performs precoding transmission based on the CSI fed back by the terminal.

The CSI fed back by the terminal includes high-precision CSI or low-precision CSI. In a scenario with fast channel changes, an effective time of the high-precision CSI is short due to the channel changes, resulting in poor robustness of the high-precision CSI. For example, in a high-speed moving scenario, performance of the high-precision CSI may be lower than performance of the low-precision CSI. In a scenario with slow channel changes, the high-precision CSI provides greater performance gains than the low-precision CSI due to higher channel accuracy.

### SUMMARY

Embodiments of this application provide a CSI feedback method and apparatus, a terminal, a network-side device, and a medium.

According to a first aspect, a CSI feedback method is provided and includes:
receiving, by a terminal, from a network-side device, configuration information for channel state information CSI; and
selecting, by the terminal, from information associated with the configuration information, part or all of the information for CSI feedback, the CSI fed back including information related to the selected information, where
a precoding matrix indicated by the CSI fed back is a product of at least two submatrices, and a dimension of at least one of the at least two submatrices is determined based on the selected information.

According to a second aspect, a CSI feedback method is provided and includes:
sending, by a network-side device, configuration information for channel state information CSI to a terminal, where part or all of information associated with the configuration information is selected for CSI feedback; and
receiving, by the network-side device, the CSI fed back by the terminal, the CSI fed back including information related to the selected information, where
a precoding matrix indicated by the CSI fed back is a product of at least two submatrices, and a dimension of at least one of the at least two submatrices is determined based on the selected information.

According to a third aspect, a CSI feedback apparatus is provided and includes:
a first receiving module, configured to receive, from a network-side device, configuration information for channel state information CSI; and
a feedback module, configured to select, from information associated with the configuration information, part or all of the information for CSI feedback, the CSI fed back including information related to the selected information, where
a precoding matrix indicated by the CSI fed back is a product of at least two submatrices, and a dimension of at least one of the at least two submatrices is determined based on the selected information.

According to a fourth aspect, a CSI feedback apparatus is provided and includes:
a first sending module, configured to send configuration information for channel state information CSI to a terminal, where part or all of information associated with the configuration information is selected for CSI feedback; and
a second receiving module, configured to receive the CSI fed back by the terminal, the CSI fed back including information related to the selected information, where
a precoding matrix indicated by the CSI fed back is a product of at least two submatrices, and a dimension of at least one of the at least two submatrices is determined based on the selected information.

According to a fifth aspect, a terminal is provided. The terminal includes a processor and a memory. The memory stores a program or instructions capable of running on the processor. When the program or instructions are executed by the processor, the steps of the method according to the first aspect are implemented.

According to a sixth aspect, a terminal is provided and includes a processor and a communication interface. The processor is configured to run a program or instructions to implement the steps of the method according to the first aspect. The communication interface is coupled to the processor.

According to a seventh aspect, a network-side device is provided. The network-side device includes a processor and a memory. The memory stores a program or instructions capable of running on the processor. When the program or instructions are executed by the processor, the steps of the method according to the second aspect are implemented.

According to an eighth aspect, a network-side device is provided and includes a processor and a communication interface. The processor is configured to run a program or instructions to implement the steps of the method according to the second aspect. The communication interface is coupled to the processor.

According to a ninth aspect, a readable storage medium is provided. The readable storage medium stores a program or instructions. When the program or instructions are executed by a processor, the steps of the method according to the first aspect are implemented, or the steps of the method according to the second aspect are implemented.

According to a tenth aspect, a wireless communication system is provided and includes a terminal and a network-side device. The terminal may be configured to perform the steps of the method according to the first aspect. The network-side device may be configured to perform the steps of the method according to the second aspect.

According to an eleventh aspect, a chip is provided. The chip includes a processor and a communication interface. The communication interface is coupled to the processor. The processor is configured to run a program or instructions to implement the method according to the first aspect or implement the steps of the method according to the second aspect.

According to a twelfth aspect, a computer program or program product is provided. The computer program or program product is stored in a storage medium. The program or program product is executed by at least one processor to implement the method according to the first aspect or implement the steps of the method according to the second aspect.

### BRIEF DESCRIPTION OF DRAWINGS

FIG. 1 is a block diagram of a wireless communication system to which an embodiment of this application may be applied;

FIG. 2 is an implementation flowchart of a CSI feedback method according to an embodiment of this application;

FIG. 3 is a schematic diagram of a dual-polarized planar antenna array according to an embodiment of this application;

FIG. 4 is a schematic diagram for determining port components according to an embodiment of this application;

FIG. 5 is another schematic diagram for determining port components according to an embodiment of this application;

FIG. 6 is a first schematic diagram showing different codebook parameters associated with different frequency domain resources according to an embodiment of this application;

FIG. 7 is a second schematic diagram showing different codebook parameters associated with different frequency domain resources according to an embodiment of this application;

FIG. 8 is a third schematic diagram showing different codebook parameters associated with different frequency domain resources according to an embodiment of this application;

FIG. 9 is a first schematic diagram showing different codebook parameters used on different time units according to an embodiment of this application;

FIG. 10 is a second schematic diagram showing different codebook parameters used on different time units according to an embodiment of this application;

FIG. 11 is a third schematic diagram showing different codebook parameters used on different time units according to an embodiment of this application;

FIG. 12 is an implementation flowchart of another CSI feedback method according to an embodiment of this application;

FIG. 13 is a schematic diagram of a structure of a CSI feedback apparatus corresponding to FIG. 2 according to an embodiment of this application;

FIG. 14 is a schematic diagram of a structure of a CSI feedback apparatus corresponding to FIG. 12 according to an embodiment of this application;

FIG. 15 is a schematic diagram of a structure of a communication device according to an embodiment of this application;

FIG. 16 is a schematic diagram of a structure of a terminal according to an embodiment of this application; and

FIG. 17 is a schematic diagram of a structure of a network-side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this application are used to distinguish between similar objects instead of describing a specified order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a quantity of objects is not limited. For example, there may be one or more first objects. In addition, the term “or” in this application indicates at least one of connected objects. For example, “A or B” covers three schemes, that is, scheme 1: including A and excluding B; scheme 2: including B and excluding A; and scheme 3: including both A and B. The character “/” generally indicates an “or” relationship between associated objects.

The term “indication” in this application may be either a direct indication (or an explicit indication) or an indirect indication (or an implicit indication). The direct indication may be understood as follows: A sender explicitly notifies a receiver, in a sent indication, of content such as specific information, an operation to be performed, or a result being requested. The indirect indication may be understood as follows: A receiver determines corresponding information based on an indication sent by a sender, or makes a decision and determines, based on a decision result, an operation to be performed or a result being requested, or the like.

It should be noted that technologies described in the embodiments of this application are not limited to a Long Term Evolution (LTE)/LTE-Advanced (LTE-A) system, and can also be used in other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), or other systems. The terms “system” and “network” in the embodiments of this application are usually used interchangeably. The described technologies may be used for the foregoing systems and radio technologies, and may also be used for other systems and radio technologies. However, in the following descriptions, a New Radio (NR) system is described for an illustrative purpose, and NR terms are used in most of the following descriptions. These technologies may also be applied to other systems than the NR system, for example, a 6th Generation (6G) communication system.

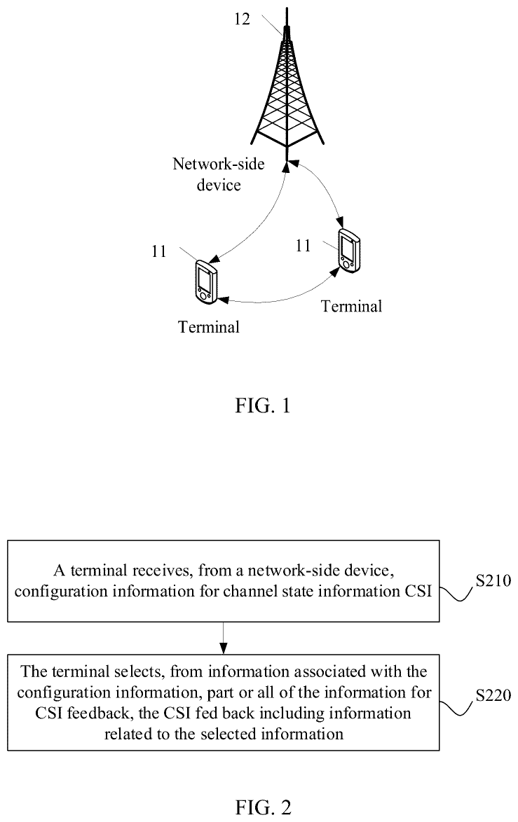

FIG. 1 is a block diagram of a wireless communication system to which an embodiment of this application may be applied. The wireless communication system includes a terminal 11 and a network-side device 12. The terminal 11 may be a terminal-side device such as a mobile phone, a tablet personal computer, a laptop computer, a notebook computer, a Personal Digital Assistant (PDA), a palmtop computer, a netbook, an Ultra-Mobile Personal Computer (UMPC), a Mobile Internet Device (MID), an Augmented Reality (AR) or Virtual Reality (VR) device, a robot, a wearable device, a flight vehicle, Vehicle User Equipment (VUE), shipborne equipment, Pedestrian User Equipment (PUE), a smart home (a home device having a wireless communication function, such as a refrigerator, a television, a washing machine, or furniture), a game console, a Personal Computer (PC), a teller machine, or a self-service machine. The wearable device includes a smartwatch, a smart band, a smart headphone, smart glasses, smart jewelry (a smart bracelet, a smart wrist chain, a smart ring, a smart necklace, a smart anklet, a smart ankle chain, or the like), a smart wristband, smart clothing, or the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in the embodiments of this application. The network-side device 12 may include an access network device or a core network device. The access network device may also be referred to as a Radio Access Network (RAN) device, a radio access network function, or a radio access network element. The access network device may include a base station, a Wireless Local Area Network (WLAN) Access Point (AS), a Wireless Fidelity (Wi-Fi) node, or the like. The base station may be referred to as a NodeB (NB), an Evolved NodeB (eNB), a next generation NodeB (gNB), a New Radio NodeB (NR NodeB), an access point, a Relay Base Station (RBS), a Serving Base Station (SBS), a Base Transceiver Station (BTS), a radio base station, a radio transceiver, a Basic Service Set (BSS), an Extended Service Set (ESS), a home NodeB (HNB), a home evolved NodeB, a Transmission Reception Point (TRP), or another appropriate term in the art. As long as the same technical effect is achieved, the base station is not limited to specific technical terms. It should be noted that in the embodiments of this application, only a base station in an NR system is used as an example, but a specific type of the base station is not limited.

For ease of understanding, the following first describes related technologies and concepts used in the embodiments of this application.

In the related art, a network-side device such as a base station configures a terminal to use Type I or Type II for CSI feedback.

Type I CSI is CSI with low precision, that is, low-precision CSI, where a precoding matrix W of each layer on each subband includes only one codebook basis vector, for example,

$$W = {W}_{1} {W}_{2} ,$$

where W₁ includes only one codebook basis vector, and W₂ represents a coefficient obtained after projection onto the basis vector. For a dual-polarized antenna array, W₁ may be expressed as:

$${W}_{1} = [ \begin{matrix}v & \\ & v\end{matrix} ] ,$$

where v represents a codebook basis vector, which is generally a Discrete Fourier Transform (DFT) vector or a Kronecker product of DFT vectors.

Type II CSI is CSI with high precision, that is, high-precision CSI, where the CSI is compressed and fed back by using a plurality of codebook basis vectors.

For Type II CSI with only spatial domain compression, a precoding matrix of each layer on each subband may be expressed as:

$$W = {W}_{1} {W}_{2} ,$$

where W₁ includes a plurality of spatial domain basis vectors, and W₂ represents a compressed coefficient. For example,

$${W}_{1} = [ \begin{matrix}{v}_{1} & {v}_{2} & {v}_{3} & {v}_{4} & & & & \\ & & & & {v}_{1} & {v}_{2} & {v}_{3} & {v}_{4}\end{matrix} ] .$$

For CSI feedback performed by using spatial domain basis vectors and frequency domain basis vectors, a precoding matrix of a layer on N3 subbands and P ports may be modeled as:

$$W = {W}_{1} {W}_{2} {W}_{f}^{H} ,$$

where W₁ includes a plurality of spatial domain basis vectors, W_{f} includes one or more frequency domain basis vectors, for example, each column in W_{f} is a frequency domain basis vector, and W₂ represents a compressed coefficient.

For CSI feedback performed by using spatial domain basis vectors, frequency domain basis vectors, and time domain basis vectors, a precoding matrix of a layer on P ports, N3 subbands, and N4 time units may be modeled as:

$$W = {W}_{1} {{W}_{2} ( {W}_{f} ⊗ {W}_{t} )}^{H} ,$$

where W₁ includes a plurality of spatial domain basis vectors, W_{f} includes one or more frequency domain basis vectors, Wₜ includes one or more time domain basis vectors, for example, each column in Wₜ is a time domain basis vector, and Wₜ represents a compressed coefficient.

In a scenario with slow channel changes, the high-precision CSI provides greater performance gains than the low-precision CSI due to higher channel accuracy. However, in a scenario with fast channel changes, an effective time of the high-precision CSI is short due to the channel changes, resulting in poor robustness of the high-precision CSI. For example, in a high-speed moving scenario, performance of the Type II CSI may be lower than performance of the Type I CSI.

The related technologies and concepts used in the embodiments of this application are described above. A CSI feedback method provided in the embodiments of this application is hereinafter described in detail by using some embodiments and application scenarios thereof with reference to the accompanying drawings.

FIG. 2 is an implementation flowchart of a CSI feedback method according to an embodiment of this application. The method includes the following steps.

S210. A terminal receives, from a network-side device, configuration information for channel state information CSI.

S220. The terminal selects, from information associated with the configuration information, part or all of the information for CSI feedback, the CSI fed back including information related to the selected information, where
a precoding matrix indicated by the CSI fed back is a product of at least two submatrices, and a dimension of at least one of the at least two submatrices is determined based on the selected information.

For ease of description, the two steps are combined for description.

The network-side device sends the configuration information for the CSI to the terminal, where the information associated with the configuration information for the CSI may include CSI feedback configuration information or Channel State Information-Reference Signal (CSI-RS) resource configuration information associated with the CSI. After receiving, from the network-side device, the configuration information for the CSI, the terminal selects part or all of the information associated with the configuration information for CSI feedback, that is, part or all of the information associated with the configuration information is selected for CSI feedback. If more information is selected from the information associated with the configuration information, it indicates that more information can be used for CSI feedback, and that precision of corresponding CSI is higher. If less information is selected from the information associated with the configuration information, it indicates that less information can be used for CSI feedback, and that precision of corresponding CSI is lower. The CSI fed back by the terminal includes the information related to the selected information.

The precoding matrix indicated by the CSI fed back by the terminal is the product of the at least two submatrices, and the dimension of the at least one of the at least two submatrices is determined based on the selected information. The information related to the selected information and included in the CSI fed back by the terminal may include information on a value of a dimension of the selected information.

The network-side device receives the CSI fed back by the terminal, and may perform precoding transmission based on the CSI fed back by the terminal.

According to the method provided in this embodiment of this application, after the terminal receives, from the network-side device, the configuration information for the CSI, the terminal selects, from the information associated with the configuration information, part or all of the information for CSI feedback. The CSI fed back includes the information related to the selected information. The precoding matrix indicated by the CSI fed back by the terminal is the product of the at least two submatrices, and the dimension of the at least one of the at least two submatrices is determined based on the selected information. Instead of merely relying on the configuration of the network-side device for CSI feedback, the terminal-side selection is added. In this way, CSI feedback with different precision can be performed in real time to adapt to channel changes, and a loss in CSI feedback accuracy or CSI feedback robustness can be effectively prevented.

In some embodiments of this application, the configuration information may include configuration information of P CSI reference signal ports, P being a positive integer, and that the terminal selects, from information associated with the configuration information, part or all of the information for CSI feedback, the CSI fed back including information related to the selected information, may include the following step:
the terminal selects, from the P CSI reference signal ports, P1 CSI reference signal ports for CSI feedback, where the CSI fed back includes information related to the selected CSI reference signal ports, and P1 is a positive integer, where
the at least one of the at least two submatrices includes one or more codebook basis vectors, and a length of each codebook basis vector is determined based on P1.

In this embodiment of this application, the network-side device may configure one or more CSI reference signal resources for CSI feedback, including the P CSI reference signal ports. The configuration information for the CSI, sent by the network-side device to the terminal, may include the configuration information of the P CSI reference signal ports. After receiving the configuration information for the CSI, the terminal selects the P1 CSI reference signal ports from the P CSI reference signal ports by measuring CSI reference signals, and performs CSI feedback based on the P1 CSI reference signal ports. The CSI fed back includes the information related to the selected CSI reference signal ports.

The precoding matrix indicated by the CSI fed back by the terminal is the product of the at least two submatrices, the at least one of the at least two submatrices includes the one or more codebook basis vectors, and the length of each codebook basis vector is determined based on P1. Optionally, the length of each codebook basis vector is P1/M1, and M1 is a positive integer. The terminal may report a value of P1 to the network-side device.

The terminal selects, from the P CSI reference signal ports configured by the network-side device, the P1 CSI reference signal ports for CSI feedback. This helps adapt to channel changes in real time to perform CSI feedback with different precision, and effectively prevents a loss in CSI feedback accuracy or CSI feedback robustness.

Optionally, the precoding matrix or part of the precoding matrix is determined based on a product of a matrix formed by the one or more codebook basis vectors and a first matrix, and the first matrix is used to indicate a selection manner for selecting the P1 CSI reference signal ports from the P CSI reference signal ports.

In other words, the precoding matrix or part of the precoding matrix indicated by the CSI fed back by the terminal may be determined based on the first matrix multiplied by the matrix formed by the one or more codebook basis vectors, and the first matrix is used to indicate the selection manner for selecting the P1 CSI reference signal ports from the P CSI reference signal ports, that is, how to select the P1 CSI reference signal ports from the P CSI reference signal ports. This helps the network-side device perform precoding transmission.

Optionally, the P1 CSI reference signal ports may include contiguous ports among the P CSI reference signal ports. In other words, the terminal selects, from the P CSI reference signal ports, P1 contiguous CSI reference signal ports for CSI feedback. For example, P=8, the P CSI reference signal ports are respectively ports 0, 1, 2, 3, 4, 5, 6, and 7 in sequence, and P1=4. One possible case of CSI reference signal ports selected from the P CSI reference signal ports is: port 2, port 3, port 4, and port 5.

Optionally, the P1 CSI reference signal ports may include equally spaced ports among the P CSI reference signal ports. In other words, the terminal selects, from the P CSI reference signal ports, P1 equally spaced CSI reference signal ports for CSI feedback. For example, P=8, the P CSI reference signal ports are respectively ports 0, 1, 2, 3, 4, 5, 6, and 7 in sequence, and P1=4. One possible case of CSI reference signal ports selected from the P CSI reference signal ports is: port 1, port 3, port 5, and port 7.

Optionally, the P1 CSI reference signal ports may include a plurality of equally spaced groups of ports among the P CSI reference signal ports, where each group of ports includes a plurality of contiguous ports. For example, P=8, the P CSI reference signal ports are respectively ports 0, 1, 2, 3, 4, 5, 6, and 7 in sequence, and P1=4. One possible case of CSI reference signal ports selected from the P CSI reference signal ports is: ports 0, 1, 3, 4, 6, and 7, where a first group of ports includes contiguous ports 0 and 1, a second group of ports includes contiguous ports 3 and 4, and a third group of ports includes contiguous ports 6 and 7. The first group of ports is spaced apart from the second group of ports by one port. The second group of ports is spaced apart from the third group of ports by one port.

Optionally, the information related to the CSI reference signal ports may include at least one of the following:
(1) information corresponding to the P1 CSI reference signal ports among the P CSI reference signal ports, such as number information, position information, and bitmap information;
(2) information corresponding to P1/K1 CSI reference signal ports among P/K1 CSI reference signal ports, such as number information, position information, and bitmap information, where K1 is a positive integer;
(3) N port components included in the P1 CSI reference signal ports, where N is a positive integer;
(4) information corresponding to N port components included in the P1 CSI reference signal ports among the P CSI reference signal ports, such as number information, position information, and bitmap information;
(5) information corresponding to N port components included in the P1 CSI reference signal ports among the P1 CSI reference signal ports, such as number information, position information, and bitmap information; and
(6) information corresponding to N port components included in the P1 CSI reference signal ports, among T largest port components corresponding to the P CSI reference signal ports, such as number information, position information, and bitmap information, where T is a positive integer.

Optionally, the N port components included in the P1 CSI reference signal ports may include N1 first port components and N2 second port components, where a product of N1 and N2 is equal to P1 or P1/M2, and N1, N2, and M2 are positive integers; and
the T largest port components corresponding to the P CSI reference signal ports may include T1 largest first port components or T2 largest second port components, where a product of T1 and T2 is equal to P or P/M3, and T1, T2, and M3 are positive integers.

Optionally, the information corresponding to the N port components included in the P1 CSI reference signal ports, among the T largest port components corresponding to the P CSI reference signal ports, may include at least one of the following:
information corresponding to the N1 first port components among the T1 largest first port components;
information corresponding to the N2 second port components among the T2 largest second port components;
a ratio of N1 to T1;
a ratio of N2 to T2;
a start number or an end number of the N1 first port components;
a start number or an end number of the N2 second port components;
a numbering interval between every two adjacent port components among the N1 first port components; and
a numbering interval between every two adjacent port components among the N2 second port components.

Optionally, a ratio of N1 to N2 is equal to a ratio of T1 to T2.

Optionally, the N1 first port components include contiguous port components among the T1 largest first port components; or
the N2 second port components include contiguous port components among the T2 largest second port components; or
the N1 first port components include equally spaced port components among the T1 largest first port components; or
the N2 second port components include equally spaced port components among the T2 largest second port components; or
the N1 first port components include a plurality of equally spaced groups of first port components among the T1 largest first port components, where each group of first port components includes a plurality of contiguous port components; or
the N2 second port components include a plurality of equally spaced groups of second port components among the T2 largest second port components, where each group of second port components includes a plurality of contiguous port components.

Optionally, N1 and N2 are selected from one or more pairs of candidate values of N1 and N2. The network-side device may configure the one or more pairs of candidate values of N1 and N2. The terminal selects, from the one or more pairs of candidate values of N1 and N2 that are configured by the network-side device, one pair of candidate values of N1 and N2 as values of N1 and N2.

The terminal reports at least one piece of the foregoing information, which helps the network-side device perform precoding transmission smoothly.

In some embodiments of this application, P1 is selected from one or more candidate values of P1. The configuration information of the P CSI reference signal ports configured by the network-side device may include information on the one or more candidate values of P1. The terminal selects, from the one or more candidate values of P1 that are configured by the network-side device, one candidate value of P1 as a value of P1.

In some embodiments of this application, the P CSI reference signal ports correspond to one or more port subsets, and the P1 CSI reference signal ports correspond to one of the one or more port subsets. The configuration information of the PCSI reference signal ports configured by the network-side device may include the one or more port subsets corresponding to the P CSI reference signal ports. The terminal selects one port subset from the one or more port subsets configured by the network-side device, where the selected port subset includes the P1 CSI reference signal ports. For example, the one or more port subsets configured by the network-side device include {port 0, port 1, port 2}, {port 1, port 3, port 5}, and {port 2, port 3, port 5, port 6}. If the terminal selects the port subset {port 1, port 3, port 5} from the port subsets, the P1 CSI reference signal ports are port 1, port 3, and port 5.

In some embodiments of this application, the configuration information may include configuration information of L codebook basis vectors, L being a positive integer, and that the terminal selects, from information associated with the configuration information, part or all of the information for CSI feedback, the CSI fed back including information related to the selected information, may include the following step:
the terminal selects, from the L codebook basis vectors, L1 codebook basis vectors for CSI feedback, where the CSI fed back includes information related to the selected codebook basis vectors, and L1 is a positive integer, where
the at least one of the at least two submatrices includes one or more codebook basis vectors, and a quantity of the codebook basis vectors is determined based on L1.

In this embodiment of this application, the network-side device sends the configuration information of the L codebook basis vectors to the terminal. The terminal may select the L1 codebook basis vectors from the L codebook basis vectors, and perform CSI feedback based on the selected L1 codebook basis vectors, where the CSI fed back includes the information related to the selected codebook basis vectors.

The precoding matrix indicated by the CSI fed back by the terminal is the product of the at least two submatrices, the at least one of the at least two submatrices includes the one or more codebook basis vectors, and the quantity of the codebook basis vectors is determined based on L1. The terminal may report a value of L1 to the network-side device.

The terminal selects, from the L codebook basis vectors configured by the network-side device, the L1 codebook basis vectors for CSI feedback. This helps adapt to channel changes in real time to perform CSI feedback with different precision, and effectively prevents a loss in CSI feedback accuracy or CSI feedback robustness.

Optionally, the precoding matrix or part of the precoding matrix is determined based on a product of a matrix formed by the L codebook basis vectors and a second matrix, and the second matrix is used to indicate a selection manner for selecting the L1 codebook basis vectors from the L codebook basis vectors.

In other words, the precoding matrix or part of the precoding matrix indicated by the CSI fed back by the terminal may be determined based on the second matrix multiplied by the matrix formed by the L codebook basis vectors, and the second matrix is used to indicate the selection manner for selecting the L1 codebook basis vectors from the L codebook basis vectors, that is, used to indicate how to select the L1 codebook basis vectors from the L codebook basis vectors. This helps the network-side device perform precoding transmission.

Optionally, the codebook basis vector indicates spatial domain information or frequency domain information or time domain information of a channel.

In some embodiments of this application, the configuration information may include configuration information of S resource units, S being a positive integer, and that the terminal selects, from information associated with the configuration information, part or all of the information for CSI feedback, the CSI fed back including information related to the selected information, may include the following step:
the terminal selects, from the S resource units, S1 resource units for CSI feedback, where the CSI fed back includes information related to the selected resource units, and S1 is a positive integer, where
the at least one of the at least two submatrices includes one or more codebook basis vectors, and a length of each codebook basis vector is determined based on S1.

In this embodiment of this application, the network-side device sends the configuration information of the S resource units to the terminal, and the terminal may select the S1 resource units from the S resource units, and perform CSI feedback based on the selected S1 resource units, where the CSI fed back includes the information related to the selected resource units.

The precoding matrix indicated by the CSI fed back by the terminal is the product of the at least two submatrices, the at least one of the at least two submatrices includes the one or more codebook basis vectors, and the length of each codebook basis vector is determined based on S1. The terminal may report a value of S1 to the network-side device.

The terminal selects, from the S resource units configured by the network-side device, the S1 resource units for CSI feedback. This helps adapt to channel changes in real time to perform CSI feedback with different precision, and effectively prevents a loss in CSI feedback accuracy or CSI feedback robustness.

Optionally, the resource unit may include at least one of a frequency domain resource unit and a time domain resource unit, where
the frequency domain resource unit may include at least one of the following:
a subband, a Resource Block (RB), a subband group, a resource block group, part of a subband, a subcarrier, a frequency band, and a Bandwidth part (BWP); or
the time domain resource unit may include at least one of the following:
a slot, a slot group, an Orthogonal Frequency Division Multiplexing (OFDM) symbol, an OFDM symbol group, a Doppler domain unit, a Doppler domain unit group, and part of a Doppler domain unit.

The subband group may be a group of contiguous or non-contiguous subbands, the resource block group may be a group of contiguous or non-contiguous resource blocks, and the part of the subband may be subband/R1, where R1 is a positive integer.

The slot group may be a group of consecutive or non-consecutive slots, the OFDM symbol group may be a group of consecutive or non-consecutive OFDM symbols, the Doppler domain unit group may be a group of contiguous or non-contiguous Doppler domain units, and the part of the Doppler domain unit may be Doppler domain unit/R2, where R2 is a positive integer.

Optionally, the S1 resource units are Type I resource units, and resource units other than the S1 resource units among the S resource units are Type II resource units, where
the Type I resource units are contiguous resource units among the S resource units, that is, S1 contiguous resource units are selected from the S resource units; or
the Type I resource units are equally spaced resource units among the S resource units, that is, S1 equally spaced resource units are selected from the S resource units; or
the Type I resource units are a plurality of equally spaced groups of resource units among the S resource units, where each group of resource units includes a plurality of contiguous resource units; or
at least one codebook parameter associated with the Type I resource units is different from at least one codebook parameter associated with the Type II resource units; or
a value of at least one codebook parameter associated with the Type I resource units is greater than or equal to a value of at least one codebook parameter associated with the Type II resource units.

Optionally, information related to the resource units may include switching information between the Type I resource units and the Type II resource units. For example, the switching information between the Type I resource units and the Type II resource units is a threshold Thr, and the terminal reports the switching information, which indicates that resource units with a codebook parameter less than or equal to Thr are the Type I resource units, and that resource units with a codebook parameter greater than Thr are the Type II resource units, or vice versa.

Optionally, the codebook parameter may include at least one of the following:
a quantity of codebook basis vectors, where for example, a quantity of at least one codebook basis vector associated with the Type I resource units is greater than 1, and a quantity of at least one codebook basis vector associated with the Type II resource units is 1; and
a quantity of quantization states of coefficients, for example, a quantity of quantization states of coefficient amplitudes or phases.

It should be noted that the CSI fed back by the terminal may include a CSI part 1 and a CSI part 2, and different CSI parameters fed back by the terminal may be transmitted in the CSI part 1 or the CSI part 2, and a bit width of at least one CSI parameter in the CSI part 2 may be determined based on a value of at least one CSI parameter in the CSI part 1. In the foregoing embodiment, a value of at least one of P1, N1, N2, L1, S1, and Thr is transmitted in the CSI part 1.

The codebook basis vector is a discrete Fourier transform vector or a Kronecker product of discrete Fourier transform vectors.

It should be noted that the foregoing related embodiments may be combined with each other to form a new embodiment. To avoid repetition, details are not described again.

For ease of understanding, the technical solutions provided in the embodiments of this application are described by using specific examples in which a network-side device is a base station.

### Example 1: A Terminal Performs Port Selection Before Compression

A base station configures one or more CSI-RS resources for CSI feedback, including P CSI-RS ports in total. By measuring a CSI-RS, a terminal selects, from the P CSI-RS ports, P1 CSI-RS ports for CSI feedback. For the selected P1 CSI-RS ports, the terminal performs CSI compression and feedback by using a codebook basis vector. Optionally, for a precoding vector or matrix on a layer, in presence of only spatial domain compression or frequency domain compression, the precoding vector or matrix may be modeled as multiplication of the following multiple submatrices:

$$W = {W }_{0} {W}_{1} {W}_{2} {W}_{f}^{H} ,$$

where W₀ represents a matrix for selecting P1 CSI-RS ports from P CSI-RS ports. Specifically, W₀ is a matrix with P rows and P1 columns, and each column includes only one element with a non-zero value, such as 1, and values of other elements are 0. W₁ indicates that compression and feedback are performed on the selected P1 CSI-RS ports by using a codebook basis vector. Optionally, W₁ includes one or more spatial domain basis vectors, each with a length of P1, or with a length of P1/2 when considering compression and feedback in two polarization directions respectively, or with a length of P1/M1 when considering compression and feedback of multiple antenna panels or subarrays respectively, where M1 is a positive integer.

In a further example, the codebook basis vector is a DFT vector, or a Kronecker product of DFT vectors.

The terminal indicates information on W₀ in CSI, for example, indicates a position of a non-zero element in each column by using a port number or a bitmap. In addition, the terminal indicates a value of P1 in the CSI, for example, encodes and reports the value of P1 or P1/M1 in a CSI part 1.

In a further example, the base station configures a plurality of candidate matrices for W₀, where each candidate matrix is used to represent a selection manner for selecting P1 CSI-RS ports from P CSI-RS ports, and the terminal selects one of the candidate matrices and reports the selected candidate matrix to the base station.

In a further example, W_{f} represents a frequency domain compression matrix, and a precoding matrix recovered by the base station may be expressed as a precoding matrix of a layer on P antenna ports and N3 subbands.

In absence of frequency domain compression, a precoding matrix of a layer on P antenna ports and each subband is:

$$W = {W}_{0} {W}_{1} {W}_{2} .$$

In a possible implementation, W₀ may be represented by the following block diagonal matrix:

$$[ \begin{matrix}{W}_{0}^{( 1 )} & 0 \\ 0 & {W}_{0}^{( 2 )}\end{matrix} ] ;$$

$$or$$

$$[ \begin{matrix}{W}_{0}^{( 1 )} & 0 \\ 0 & {W}_{0}^{( M 1 )}\end{matrix} ] ,$$

where M1 is a positive integer, and a quantity of columns included in each submatrix is P1/M1, that is, the terminal selects P1/M1 CSI-RS ports from every P/M1 CSI-RS ports. Each submatrix may be the same or different. When each submatrix is the same, the terminal needs to report only information on the P1/M1 CSI-RS ports selected from every P/M1 CSI-RS ports. In addition, the matrix W₁ may also be expressed as a diagonal matrix formed by a plurality of submatrices, and each submatrix includes one or more codebook basis vectors with a length of P1/M1.

In presence of spatial domain compression, frequency domain compression, and time domain compression, a precoding vector or matrix on a layer may be modeled as multiplication of the following multiple submatrices:

$$W = {W}_{0} {W}_{1} {{W}_{2} ( {W}_{f} ⊗ {W}_{t} )}^{H} ,$$

This matrix represents addition of a time domain compression matrix Wₜ on a basis of frequency domain compression, and a precoding matrix recovered by the base station may be expressed as a precoding matrix of a layer on P antenna ports, N3 subbands, and N4 time units. In this example, the information and structure represented by W₀ and W₁ may be the same as those in the previous example. Optionally, W₀ represents a matrix for selecting the P1 CSI-RS ports from the P CSI-RS ports. Optionally, W₀ is a matrix with P rows and P1 columns, and each column includes only one element with a non-zero value, such as 1, and values of other elements are 0. W₁ indicates that compression and feedback are performed on the selected P1 CSI-RS ports by using a codebook basis vector. Optionally, W₁ includes one or more spatial domain basis vectors, each with a length of P1, or with a length of P1/2 when considering compression and feedback in two polarization directions respectively, or with a length of P1/M1 when considering compression and feedback of multiple antenna panels or subarrays respectively, where M1 is a positive integer.

In a further example, the codebook basis vector is a DFT vector, or a Kronecker product of DFT vectors.

The terminal indicates information on W₀ in CSI, for example, indicates a position of a non-zero element in each column by using a port number or a bitmap. In addition, the terminal indicates a value of P1 in the CSI, for example, encodes and reports the value of P1 or P1/M1 in a CSI part 1.

In a further example, the base station configures a plurality of candidate matrices for W₀, where each candidate matrix is used to represent a selection manner for selecting P1 CSI-RS ports from P CSI-RS ports, and the terminal selects one of the candidate matrices and reports the selected candidate matrix to the base station.

In a further example, if P CSI-RS ports and P1 CSI-RS ports include a dual-polarized array, the terminal may report number information of P1/2 CSI-RS ports among first P/2 CSI-RS ports (polarization 0) of the P CSI-RS ports, and number information of remaining P1/2 CSI-RS ports may be obtained by adding P/2 to port numbers in the first half. Optionally, numbers of the P1/2 CSI-RS ports are contiguous.

In a further example, if P CSI-RS ports and P1 CSI-RS ports include a dual-polarized array, the terminal may report and indicate number information of P1/2M1 CSI-RS ports among first P/2M1 CSI-RS ports (polarization 0) of P/M1 CSI-RS ports associated with a first CSI-RS, or a plurality of CSI-RSs share port indication information. Optionally, numbers of the P1/2M1 CSI-RS ports are contiguous.

In a further example, optionally, for calculation of a Channel Quality Indicator (CQI), it is assumed that data symbols of m layers (layer) are sent through the selected P1 CSI-RS ports or P1/M1 CSI-RS ports.

Alternatively,

$$[ [ \begin{matrix}{y}^{( P 0 )} ( i ) \\ … \\ {y}^{( P 0 + P - 1 )} ( i )\end{matrix} ] ] = {W}_{0} ( i ) W ( i ) [ \begin{matrix}{x}^{( 0 )} ( i ) \\ … \\ {x}^{( m - 1 )} ( i )\end{matrix} ] ,$$

where W₀ (i) is obtained based on a port indication, and P0 indicates a number of a first CSI-RS port.

In a further example, W_{f} represents a frequency domain compression matrix. In absence of frequency domain compression, W_{f} is an identity matrix. A precoding matrix recovered by the base station may be expressed as a precoding matrix of a layer on P antenna ports and N3 subbands.

In another specific example, W₀ may be represented by the following block diagonal matrix:

$$[ \begin{matrix}{W}_{0}^{( 1 )} & 0 \\ 0 & {W}_{0}^{( 2 )}\end{matrix} ] ,$$

$$or$$

$$[ \begin{matrix}{W}_{0}^{( 1 )} & & \\ & ⋱ & \\ & & {W}_{0}^{( M 1 )}\end{matrix} ] ,$$

where M1 is a positive integer, and a quantity of columns included in each submatrix is P1/M1, that is, the terminal selects P1/M1 CSI-RS ports from every P/M1 CSI-RS ports. Each submatrix may be the same or different. When each submatrix is the same, only information on the P1/M1 CSI-RS ports selected from every P/M1 CSI-RS ports needs to be reported. In addition, the matrix W₁ may also be expressed as a diagonal matrix formed by a plurality of submatrices, and each submatrix includes one or more codebook basis vectors with a length of P1/M1.

In a further example, the base station may configure a plurality of candidate values of P1, and the terminal selects one candidate value of P1 as a value of P1 and reports the value to the base station.

In a further example, a quantity of CSI computing units (CPU) occupied by the terminal is related to a quantity of candidate values of P1.

In a further example, the terminal selects a value of P1 to compute CSI only when a time interval between a last CSI-RS or CSI-RS occasion and a CSI reporting time (such as a slot or an OFDM symbol) exceeds a threshold, or if a plurality of candidate values of P1 are configured, the terminal uses a default candidate value of P1 (for example, a smallest candidate value of P1) as the value of P1 to compute CSI.

By using the foregoing examples, in a scenario in which the terminal is moving at a high speed, the terminal can select a quantity of most suitable or most reliable transmission antenna ports through real-time channel measurement, to form a wider beam at the base station side to cope with the high-speed movement of the terminal and improve performance of data transmission.

### Example 2: A Terminal Reports N1 and N2

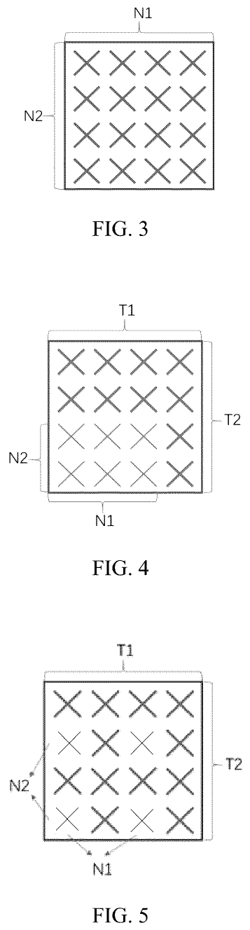

A base station configures one or more CSI-RS resources for CSI feedback, including P CSI-RS ports in total. A terminal selects, from the P CSI-RS ports, P1 CSI-RS ports for CSI feedback. For the selected P1 CSI-RS ports, the terminal performs CSI compression and feedback by using a codebook basis vector. When the terminal generates a codebook basis vector, N1 first port components or N2 second port components are generally required. For example, for a dual-polarized planar antenna array, a rectangular antenna array in each polarization direction includes N1 horizontal antenna ports and N2 vertical antenna ports, and a total quantity of antenna ports is 2*N1*N2, as shown in FIG. 3.

A codebook basis vector used on ports in each polarization direction (for example, ports in the first half or ports in the second half) is expressed in the following form:

$${v}_{1} ⊗ {v}_{2} ,$$

where v₁ is a codebook basis vector component formed on the N1 first port components, and v₂ is a codebook basis vector component formed on the N2 second port components. For example, v₁ and v₂ are DFT vectors, and a final codebook basis vector is a Kronecker product of the DFT vectors.

For P1 antenna ports selected by the terminal, the terminal may report N1 and N2, where N1*N2=P1, or N1*N2=P1/2, or N1*N2=P1/M2, and M2 is a positive integer. In addition, the terminal may report number information of the N1 first port components in the P CSI-RS ports or P1 CSI-RS ports, or report number information of the N2 second port components in the P CSI-RS ports or P1 CSI-RS ports.

In addition, the terminal may also determine values of N1 and N2 based on a predefined rule, including but not limited to, a ratio of N1 to N2 meets a relationship, and port numbers occupied by N1 and N2 in the P CSI-RS ports meet a relationship. For example, N1 and N2 represent contiguous ports, or equally spaced ports, or equally spaced contiguous ports of the P1 CSI-RS ports, among the P CSI-RS ports.

In another example, the base station configures largest port components, that is, T1 largest first port components and T2 largest second port components, corresponding to the total of P CSI-RS ports, where T1*T2=P, or T1*T2=P/M3, and M3 is a positive integer. The terminal may determine N1, N2, and corresponding port components based on T1 and T2.

In a possible manner, the terminal reports information corresponding to the N1 first port components among the T1 largest first port components, or information corresponding to the N2 second port components among the T2 largest second port components. For example, the terminal reports at least one piece of the following information: a ratio of N1 to T1, a ratio of N2 to T2, a start number or an end number of the N1 first port components, a start number or an end number of the N2 second port components, a numbering interval between every two adjacent port components among the N1 first port components, and a numbering interval between every two adjacent port components among the N2 second port components.

In another possible manner, the terminal determines N1, N2, and corresponding port components based on T1, T2, and a predefined rule. For example, N1, N2, and corresponding port components meet at least one of the following conditions: A ratio of N1 to N2 is equal to a ratio of T1 to T2, the N1 first port components include contiguous port components among the T1 largest first port components, and the N2 second port components include contiguous port components among the T2 largest second port components. As shown in FIG. 4, the N1 first port components include equally spaced port components among the T1 largest first port components. The N2 second port components include equally spaced port components among the T2 largest second port components, as shown in FIG. 5.

In a further example, the base station configures one or more pairs of candidate values of N1 and N2. The terminal selects one pair of candidate values of N1 and N2 from the one or more pairs of candidate values of N1 and N2, as values of N1 and N2.

### Example 3: A Terminal Reports a Quantity of Basis Vectors

A base station configures, in configuration information for CSI, a terminal to feed back CSI by using L codebook basis vectors, where the codebook basis vectors may be spatial domain basis vectors, frequency domain basis vectors, or time domain basis vectors.

For CSI feedback performed by using only spatial domain basis vectors, a precoding matrix of a layer on a subband on P CSI-RS ports may be modeled as:

$$W = {W}_{1} {W}_{2} , \qquad ( 1 )$$

where W₁ includes a spatial domain basis vector, and W₂ represents a compressed coefficient.

For CSI feedback performed by using spatial domain basis vectors and frequency domain basis vectors, a precoding matrix of a layer on N3 subbands and P CSI-RS ports may be modeled as:

$$W = {W}_{1} {W}_{2} {W}_{f}^{H} , \qquad ( 2 )$$

where W₁ includes a spatial domain basis vector, W_{f} includes a frequency domain basis vector, and W₂ represents a compressed coefficient.

For CSI feedback performed by using spatial domain basis vectors, frequency domain basis vectors, and time domain basis vectors, a precoding matrix of a layer on P CSI-RS ports, N3 subbands, and N4 time units may be modeled as:

$$W = {W}_{1} {{W}_{2} ( {W}_{f} ⊗ {W}_{t} )}^{H} , \qquad ( 3 )$$

where W₁ includes a spatial domain basis vector, W_{f} includes a frequency domain basis vector, Wₜ includes a time domain basis vector, and W₂ represents a compressed coefficient.

In the foregoing formulas (1), (2), and (3), the spatial domain basis vector, the frequency domain basis vector, or the time domain basis vector is a DFT vector or a Kronecker product of DFT vectors.

After the terminal determines the spatial domain basis vectors, frequency domain basis vectors, or time domain basis vectors based on a value of L configured by the base station, the terminal selects L1 spatial domain basis vectors, frequency domain basis vectors, or time domain basis vectors for CSI feedback. The terminal reports the value of L1. L1 is a positive integer. In a further example, L1=1. In a further example, L1=1 basis vector (for example, a frequency domain basis vector or a time domain basis vector) selected by the terminal is a default basis vector (for example, a basis vector with a number 0 or an all-one basis vector). In this case, the terminal does not report the number of the selected basis vector.

For spatial domain basis vectors, the terminal obtains new basis vectors by multiplying the matrix W₁, which is formed by L spatial domain basis vectors configured by the base station, by a matrix used to indicate a selection manner for selecting L1 basis vectors from the L spatial domain basis vectors. Optionally, in the precoding matrix, W₁ in (1), (2), and (3) is replaced with a matrix W₁Wₛ, where Wₛ is a matrix with L rows and L1 columns, and each column includes only one element with a non-zero value (such as 1), and values of other elements are 0. In a further example, Wₛ is the following block diagonal matrix:

$$[ \begin{matrix}{W}_{s}^{( 1 )} & & \\ & ⋱ & \\ & & {W}_{s}^{( M )}\end{matrix} ] ,$$

where M is a positive integer greater than or equal to 2, and each diagonal block represents a matrix for selecting L1/M basis vectors from L/M basis vectors.

Similarly, for frequency domain basis vectors, the terminal obtains new basis vectors by multiplying the matrix W_{f}, which is formed by L frequency domain basis vectors configured by the base station, by a matrix used to indicate a selection manner for selecting L1 basis vectors from the L frequency domain basis vectors. Optionally, in the precoding matrix, W_{f} in (2) and (3) is replaced with a matrix W (Wₛ, where Wₛ is a matrix with L rows and L1 columns, and each column includes only one element with a non-zero value (such as 1), and values of other elements are 0.

Similarly, for time domain basis vectors, the terminal obtains new basis vectors by multiplying the matrix Wₜ, which is formed by L time domain basis vectors configured by the base station, by a matrix used to indicate a selection manner for selecting L1 basis vectors from the L time domain basis vectors. Optionally, in the precoding matrix, Wₜ in (3) is replaced with a matrix WₜWₛ, where Wₛ is a matrix with L rows and L1 columns, and each column includes only one element with a non-zero value (such as 1), and values of other elements are 0.

In the foregoing manner in which the terminal feeds back the quantity of basis vectors, the terminal can change a granularity of quantization of a channel matrix in spatial domain, frequency domain, or time domain based on a real-time change of a channel, to obtain feedback parameters more suitable for the current channel, jointly optimize channel feedback accuracy and reliability, and achieve higher CSI feedback performance.

### Example 4: Mixed Type I+Type II, Distinguished by Subbands

A base station configures frequency domain resources associated with CSI feedback, for example, S subbands associated with CSI feedback, and a terminal feeds back CSI on the associated frequency domain resources. In a scenario with a fast channel change, different frequency domain resources require different CSI accuracy or CSI robustness, and the terminal may use different codebook parameters on different frequency domain resources to improve CSI feedback performance.

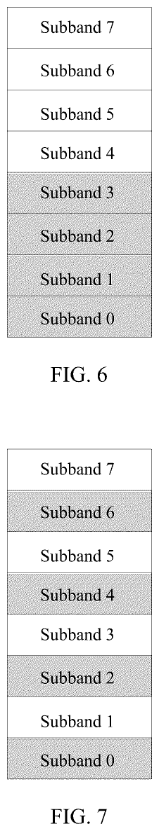

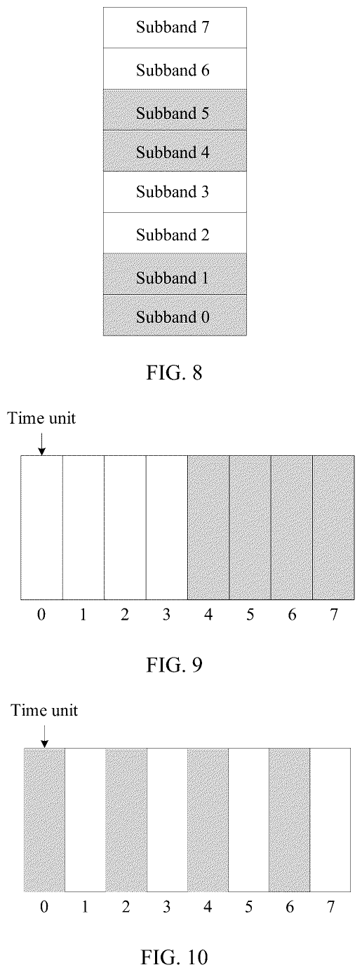

In a possible manner, the terminal uses different codebook parameters on different frequency domain resources based on configuration information configured by the base station or a predefined rule. For example, the base station configures a plurality of codebook parameters and indicates an association relationship between different codebook parameters and frequency domain resources associated with CSI. For example, subbands associated with Type I codebook parameters are Type I subbands and subbands associated with Type II codebook parameters are Type II subbands, and the base station may indicate, by using configuration information, subbands included in the Type I subbands or the Type II subbands. Alternatively, the terminal determines the Type I subbands or the Type II subbands based on some predefined rules. For example, the Type I subbands (or the Type II subbands) are contiguous subbands among S subbands. As shown in FIG. 6, subbands 0 to 3 correspond to the Type I codebook parameters, for example, a quantity of codebook basis vectors is 1, and subbands 4 to 7 correspond to the Type II codebook parameters, for example, a quantity of codebook basis vectors is 4. Alternatively the Type I subbands (or the Type II subbands) are equally spaced subbands among S subbands. As shown in FIG. 7, subbands 0, 2, 4, and 6 correspond to the Type I codebook parameters, for example, a quantity of codebook basis vectors is 1, and subbands 1, 3, 5, and 7 correspond to the Type II codebook parameters, for example, a quantity of codebook basis vectors is 4. Alternatively, the Type I subbands (or the Type II subbands) are equally spaced contiguous subbands among S subbands. As shown in FIG. 8, subbands 0, 1, 4, and 5 correspond to the Type I codebook parameters, for example, a quantity of codebook basis vectors is 1, and subbands 2, 3, 6, and 7 correspond to the Type II codebook parameters, for example, a quantity of codebook basis vectors is 4.

The codebook parameters include at least a quantity of codebook basis vectors, a quantity of quantization states of coefficients, and the like. For example, a quantity of at least one codebook basis vector associated with the Type I subbands is 1, and a quantity of at least one codebook basis vector associated with the Type II subbands is greater than 1.

In another possible manner, the terminal reports a manner of subband division using different codebook parameters. The terminal selects, from the total of S subbands, S1 subbands for CSI feedback using the Type I codebook parameters, and the selected subbands are referred to as Type I subbands. Among the S subbands, those not included in the S1 subbands use the Type II codebook parameters, and are referred to as Type II subbands. At least one codebook parameter associated with the Type I subbands is different from at least one codebook parameter associated with the Type II subbands. For example, a value of the at least one codebook parameter associated with the Type I subbands is greater than a value of the at least one codebook parameter associated with the Type II subbands. In a particular example, precoding for the Type I subbands includes a plurality of codebook basis vectors per layer, and precoding for the Type II subbands includes one codebook basis vector per layer. A length of each subband (for example, W_{f} in the foregoing formulas (2) and (3)) associated with the selected Type I subbands is equal to a quantity S1 of subbands included in the Type I subbands.

Optionally, the Type I subbands are S1 contiguous subbands among the S subbands; and the terminal reports switching information between the Type I subbands and the Type II subbands. For example, the terminal reports a threshold Thr. Subbands with a codebook parameter less than or equal to Thr are the Type I subbands, and subbands with a codebook parameter greater than Thr are the Type II subbands, or vice versa.

Optionally, the Type I subbands are equally spaced S1 subbands among the S subbands.

Optionally, the Type I subbands are contiguous subbands spaced by a quantity among the S subbands.

Optionally, the terminal reports only CSI associated with the Type I subbands and omits CSI associated with the Type II subbands.

### Example 5: Mixed Type I+Type II, Distinguished by Time Domain Units

A base station configures time domain resources associated with CSI feedback, for example, S time units associated with CSI feedback, and a terminal feeds back CSI on the associated time units. In a scenario with a fast channel change, different time units require different CSI accuracy or CSI robustness, and the terminal may use different codebook parameters on different time units to improve CSI feedback performance. For example, the terminal can only predict high-precision CSI on an earlier time unit, but cannot predict high-precision CSI on a later time unit.

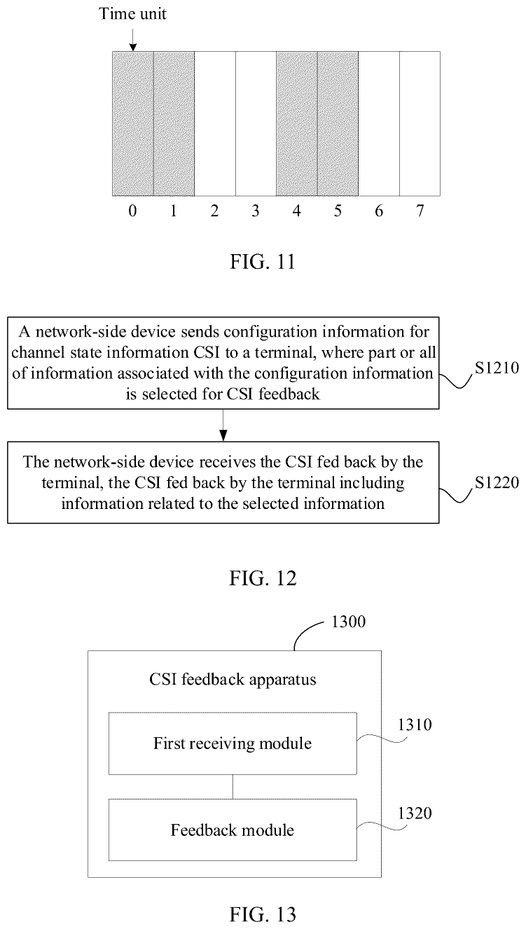

In a possible manner, the terminal uses different codebook parameters on different time units based on configuration information configured by the base station or a predefined rule. For example, the base station configures a plurality of codebook parameters and indicates an association relationship between different codebook configuration parameters and time units associated with CSI. For example, time units associated with the Type I codebook parameters are Type I time units, and time units associated with the Type II codebook parameters are Type II time units. The base station may indicate, by using configuration information, time units included in the Type I time units or the Type II time units. Alternatively, the terminal determines the Type I time units or the Type II time units based on some predefined rules. For example, the Type I time units (or Type II time units) are consecutive time units among S time units. As shown in FIG. 9, time units 4 to 7 correspond to the Type I codebook parameters, for example, a quantity of codebook basis vectors is 1, and time units 0 to 3 correspond to the Type II codebook parameters, for example, a quantity of codebook basis vectors is 4. Alternatively, the Type I time units (or Type II time units) are equally spaced time units among S time units. As shown in FIG. 10, time units 0, 2, 4, and 6 correspond to the Type I codebook parameters, for example, a quantity of codebook basis vectors is 1, and time units 1, 3, 5, and 7 correspond to the Type II codebook parameters, for example, a quantity of codebook basis vectors is 4. Alternatively, the Type I time units (or Type II time units) are equally spaced consecutive time units among S time units. As shown in FIG. 11, time units 0, 1, 4, and 5 correspond to the Type I codebook parameters, for example, a quantity of codebook basis vectors is 1, and time units 2, 3, 6, and 7 correspond to the Type II codebook parameters, for example, a quantity of codebook basis vectors is 4.

The codebook parameters include at least a quantity of codebook basis vectors, a quantity of quantization states of coefficients, and the like. For example, a quantity of at least one codebook basis vector associated with the Type I time units is 1, and a quantity of at least one codebook basis vector associated with the Type II time units is greater than 1.

In another possible manner, the terminal reports a manner of time unit division using different codebook parameters. The terminal selects, from the total of S time units, S1 time units for CSI feedback using the Type I codebook parameters, and the selected time units are referred to as Type I time units. Among the S time units, those not included in the S1 time units use the Type II codebook parameters, and are referred to as Type II time units. At least one codebook parameter associated with the Type I time units is different from at least one codebook parameter associated with the Type II time units. For example, a value of the at least one codebook parameter associated with the Type I time units is greater than a value of the at least one codebook parameter associated with the Type II time units. In a particular example, precoding for the Type I time units includes a plurality of codebook basis vectors per layer, and precoding for the Type II time units includes one codebook basis vector per layer. A length of each time domain basis vector (for example, Wₜ in the foregoing formula (3)) associated with the selected Type I time units is equal to a quantity S1 of time units included in the Type I time units.

Optionally, the Type I time units are S1 consecutive time units among the S time units; and the terminal reports switching information between the Type I time units and the Type II time units. For example, the terminal reports a threshold Thr. Time units with a codebook parameter less than or equal to Thr are Type I time units, and time units with a codebook parameter greater than Thr are Type II time units, or vice versa.

Optionally, the Type I time units are equally spaced S1 time units among the S time units.

Optionally, the Type I time units are consecutive time units spaced by a quantity among the S time units.

Optionally, the terminal reports only CSI associated with the Type I time units and omits CSI associated with the Type II time units.

### Example 6: a Terminal Reports a Quantity of Quantization States

To balance CSI accuracy and CSI robustness, and especially CSI robustness in a high-speed scenario, a terminal may report a quantity of quantization states of a coefficient amplitude or phase in CSI. For example, the terminal reports a quantity of quantization states of a non-zero coefficient amplitude or phase included in the matrix W₂ in the formulas (1), (2), and (3), or the terminal reports a quantity of bits occupied by each non-zero coefficient amplitude or phase in W₂.

Optionally, a plurality of amplitude or phase quantization tables are predefined or configured by a base station by using signaling, for example, an amplitude 3-bit quantization table or 4-bit quantization table, and a phase 3-bit quantization table or 4-bit quantization table. The terminal reports which table is used for amplitude or phase quantization.

### Example 7: A Terminal Updates a Maximum Quantity of Flows (Rank)

A terminal may improve CSI feedback robustness by updating a maximum rank. For example, the terminal reports the maximum rank by using a MAC Control Element (MAC CE) or Uplink Control Information (UCI), to determine the maximum rank for subsequent CSI feedback (for example, in a subsequent period of time or before the maximum rank is reported next time).

According to the technical solutions provided in the embodiments of this application, in a scenario in which the terminal is moving at a high speed, the terminal can select the most suitable or most reliable configuration information for CSI through real-time channel measurement, and perform CSI feedback based on the selected information, which helps improve data transmission performance.

Corresponding to the foregoing method embodiment, an embodiment of this application further provides a CSI feedback method. Referring to FIG. 12, the method includes the following steps:

S1210. A network-side device sends configuration information for channel state information CSI to a terminal, where part or all of information associated with the configuration information is selected for CSI feedback.

S1220. The network-side device receives the CSI fed back by the terminal, the CSI fed back including information related to the selected information, where
a precoding matrix indicated by the CSI fed back is a product of at least two submatrices, and a dimension of at least one of the at least two submatrices is determined based on the selected information.

According to the method provided in this embodiment of this application, the network-side device sends the configuration information for the CSI to the terminal, and the terminal selects, from the information associated with the configuration information, part or all of the information for CSI feedback. The CSI fed back includes the information related to the selected information. The precoding matrix indicated by the CSI fed back is the product of the at least two submatrices, and the dimension of the at least one of the at least two submatrices is determined based on the selected information. Instead of merely relying on the configuration of the network-side device for CSI feedback, the terminal-side selection is added. In this way, CSI feedback with different precision can be performed in real time to adapt to channel changes, and a loss in CSI feedback accuracy or CSI feedback robustness can be effectively prevented.

In some embodiments of this application, the configuration information includes configuration information of P CSI reference signal ports, where P is a positive integer;
that part or all of information associated with the configuration information is selected for CSI feedback includes: P1 CSI reference signal ports among the P CSI reference signal ports are selected for CSI feedback, where P1 is a positive integer; and
the information related to the selected information includes information related to the selected CSI reference signal ports, where
the at least one of the at least two submatrices includes one or more codebook basis vectors, and a length of each codebook basis vector is determined based on P1.

In some embodiments of this application, the length of each codebook basis vector is P1/M1, and M1 is a positive integer.

In some embodiments of this application, the precoding matrix or part of the precoding matrix is determined based on a product of a matrix formed by the one or more codebook basis vectors and a first matrix, and the first matrix is used to indicate a selection manner for selecting the P1 CSI reference signal ports from the P CSI reference signal ports.

In some embodiments of this application, the P1 CSI reference signal ports include contiguous ports among the P CSI reference signal ports; or
the P1 CSI reference signal ports include equally spaced ports among the P CSI reference signal ports; or
the P1 CSI reference signal ports include a plurality of equally spaced groups of ports among the P CSI reference signal ports, where each group of ports includes a plurality of contiguous ports.

In some embodiments of this application, the information related to the CSI reference signal ports includes at least one of the following:
information corresponding to the P1 CSI reference signal ports among the P CSI reference signal ports;
information corresponding to P1/K1 CSI reference signal ports among P/K1 CSI reference signal ports, where K1 is a positive integer;
N port components included in the P1 CSI reference signal ports, where N is a positive integer;
information corresponding to N port components included in the P1 CSI reference signal ports among the P CSI reference signal ports;
information corresponding to N port components included in the P1 CSI reference signal ports among the P1 CSI reference signal ports; and
information corresponding to N port components included in the P1 CSI reference signal ports, among T largest port components corresponding to the P CSI reference signal ports, where T is a positive integer.

In some embodiments of this application, the N port components include N1 first port components and N2 second port components, where a product of N1 and N2 is equal to P1 or P1/M2, and N1, N2, and M2 are positive integers; and
the T largest port components include T1 largest first port components or T2 largest second port components, where a product of T1 and T2 is equal to P or P/M3, and T1, T2, and M3 are positive integers.

In some embodiments of this application, the information corresponding to the N port components included in the P1 CSI reference signal ports, among the T largest port components corresponding to the P CSI reference signal ports, includes at least one of the following:
information corresponding to the N1 first port components among the T1 largest first port components;
information corresponding to the N2 second port components among the T2 largest second port components;
a ratio of N1 to T1;
a ratio of N2 to T2;
a start number or an end number of the N1 first port components;
a start number or an end number of the N2 second port components;
a numbering interval between every two adjacent port components among the N1 first port components; and
a numbering interval between every two adjacent port components among the N2 second port components.

In some embodiments of this application, a ratio of N1 to N2 is equal to a ratio of T1 to T2.

In some embodiments of this application, the N1 first port components include contiguous port components among the T1 largest first port components; or
the N2 second port components include contiguous port components among the T2 largest second port components; or
the N1 first port components include equally spaced port components among the T1 largest first port components; or
the N2 second port components include equally spaced port components among the T2 largest second port components; or
the N1 first port components include a plurality of equally spaced groups of first port components among the T1 largest first port components, where each group of first port components includes a plurality of contiguous port components; or
the N2 second port components include a plurality of equally spaced groups of second port components among the T2 largest second port components, where each group of second port components includes a plurality of contiguous port components.

In some embodiments of this application, the configuration information of the P CSI reference signal ports includes information on one or more pairs of candidate values of N1 and N2.

In some embodiments of this application, the configuration information of the P CSI reference signal ports includes at least one of the following:
information on one or more candidate values of P1; and
information on one or more port subsets corresponding to the P CSI reference signal ports.

In some embodiments of this application, the configuration information includes configuration information of L codebook basis vectors, where L is a positive integer;
that part or all of information associated with the configuration information is selected for CSI feedback includes: L1 codebook basis vectors among the L codebook basis vectors are selected for CSI feedback, where L1 is a positive integer; and
the information related to the selected information includes information related to the selected codebook basis vectors, where
the at least one of the at least two submatrices includes one or more codebook basis vectors, and a quantity of the codebook basis vectors is determined based on L1.

In some embodiments of this application, the precoding matrix or part of the precoding matrix is determined based on a product of a matrix formed by the L codebook basis vectors and a second matrix, and the second matrix is used to indicate a selection manner for selecting the L1 codebook basis vectors from the L codebook basis vectors.

In some embodiments of this application, the codebook basis vector indicates spatial domain information or frequency domain information or time domain information of a channel.

In some embodiments of this application, the configuration information includes configuration information of S resource units, where S is a positive integer;
that part or all of information associated with the configuration information is selected for CSI feedback includes: S1 resource units among the S resource units are selected for CSI feedback, where S1 is a positive integer; and
the information related to the selected information includes information related to the selected resource units, where
the at least one of the at least two submatrices includes one or more codebook basis vectors, and a length of each codebook basis vector is determined based on S1.

In some embodiments of this application, the resource unit includes at least one of a frequency domain resource unit and a time domain resource unit, where
the frequency domain resource unit includes at least one of the following:
a subband, a resource block, a subband group, a resource block group, part of a subband, a subcarrier, a frequency band, and a bandwidth part; or
the time domain resource unit includes at least one of the following:
a slot, a slot group, an orthogonal frequency division multiplexing symbol, an orthogonal frequency division multiplexing symbol group, a Doppler domain unit, a Doppler domain unit group, and part of a Doppler domain unit.

In some embodiments of this application, the S1 resource units are Type I resource units, and resource units other than the S1 resource units among the S resource units are Type II resource units, where
the Type I resource units are contiguous resource units among the S resource units; or
the Type I resource units are equally spaced resource units among the S resource units; or
the Type I resource units are a plurality of equally spaced groups of resource units among the S resource units, where each group of resource units includes a plurality of contiguous resource units; or
at least one codebook parameter associated with the Type I resource units is different from at least one codebook parameter associated with the Type II resource units; or
a value of at least one codebook parameter associated with the Type I resource units is greater than or equal to a value of at least one codebook parameter associated with the Type II resource units.

In some embodiments of this application, information related to the resource units includes switching information between the Type I resource units and the Type II resource units.

In some embodiments of this application, the codebook parameter includes at least one of the following:
a quantity of codebook basis vectors; and
a quantity of quantization states of coefficients.

In some embodiments of this application, the codebook basis vector is a discrete Fourier transform vector or a Kronecker product of discrete Fourier transform vectors.

The CSI feedback method provided in this embodiment of this application can implement each process implemented in the method embodiment in FIG. 2 to FIG. 11, with the same technical effect achieved. To avoid repetition, details are not described herein again.

The CSI feedback method provided in the embodiments of this application may be performed by a CSI feedback apparatus. A CSI feedback apparatus provided in the embodiments of this application is described by assuming that the CSI feedback method in the embodiments of this application is performed by the CSI feedback apparatus.

As shown in FIG. 13, a CSI feedback apparatus 1300 includes the following modules:
a first receiving module 1310, configured to receive, from a network-side device, configuration information for channel state information CSI; and
a feedback module 1320, configured to select, from information associated with the configuration information, part or all of the information for CSI feedback, the CSI fed back including information related to the selected information, where
a precoding matrix indicated by the CSI fed back is a product of at least two submatrices, and a dimension of at least one of the at least two submatrices is determined based on the selected information.

In this embodiment of this application, after the apparatus receives, from the network-side device, the configuration information for the CSI, the apparatus selects, from the information associated with the configuration information, part or all of the information for CSI feedback. The CSI fed back includes the information related to the selected information. The precoding matrix indicated by the CSI fed back by the apparatus is the product of the at least two submatrices, and the dimension of the at least one of the at least two submatrices is determined based on the selected information. Instead of merely relying on the configuration of the network-side device for CSI feedback, the terminal-side selection is added. In this way, CSI feedback with different precision can be performed in real time to adapt to channel changes, and a loss in CSI feedback accuracy or CSI feedback robustness can be effectively prevented.

In some embodiments of this application, the configuration information includes configuration information of P CSI reference signal ports, P being a positive integer, and the feedback module 1320 is configured to:
select, from the P CSI reference signal ports, P1 CSI reference signal ports for CSI feedback, where the CSI fed back includes information related to the selected CSI reference signal ports, and P1 is a positive integer, where
the at least one of the at least two submatrices includes one or more codebook basis vectors, and a length of each codebook basis vector is determined based on P1.

In some embodiments of this application, the length of each codebook basis vector is P1/M1, and M1 is a positive integer.

In some embodiments of this application, the precoding matrix or part of the precoding matrix is determined based on a product of a matrix formed by the one or more codebook basis vectors and a first matrix, and the first matrix is used to indicate a selection manner for selecting the P1 CSI reference signal ports from the P CSI reference signal ports.

In some embodiments of this application, the P1 CSI reference signal ports include contiguous ports among the P CSI reference signal ports; or
the P1 CSI reference signal ports include equally spaced ports among the P CSI reference signal ports; or
the P1 CSI reference signal ports include a plurality of equally spaced groups of ports among the P CSI reference signal ports, where each group of ports includes a plurality of contiguous ports.

In some embodiments of this application, the information related to the CSI reference signal ports includes at least one of the following:
information corresponding to the P1 CSI reference signal ports among the P CSI reference signal ports;
information corresponding to P1/K1 CSI reference signal ports among P/K1 CSI reference signal ports, where K1 is a positive integer;
N port components included in the P1 CSI reference signal ports, where N is a positive integer;
information corresponding to N port components included in the P1 CSI reference signal ports among the P CSI reference signal ports;
information corresponding to N port components included in the P1 CSI reference signal ports among the P1 CSI reference signal ports; and
information corresponding to N port components included in the P1 CSI reference signal ports, among T largest port components corresponding to the P CSI reference signal ports, where T is a positive integer.

In some embodiments of this application, the N port components include N1 first port components and N2 second port components, where a product of N1 and N2 is equal to P1 or P1/M2, and N1, N2, and M2 are positive integers; and
the T largest port components include T1 largest first port components or T2 largest second port components, where a product of T1 and T2 is equal to P or P/M3, and T1, T2, and M3 are positive integers.

In some embodiments of this application, the information corresponding to the N port components included in the P1 CSI reference signal ports, among the T largest port components corresponding to the P CSI reference signal ports, includes at least one of the following:
information corresponding to the N1 first port components among the T1 largest first port components;
information corresponding to the N2 second port components among the T2 largest second port components;
a ratio of N1 to T1;
a ratio of N2 to T2;
a start number or an end number of the N1 first port components;
a start number or an end number of the N2 second port components;
a numbering interval between every two adjacent port components among the N1 first port components; and
a numbering interval between every two adjacent port components among the N2 second port components.

In some embodiments of this application, a ratio of N1 to N2 is equal to a ratio of T1 to T2.

In some embodiments of this application, the N1 first port components include contiguous port components among the T1 largest first port components; or
the N2 second port components include contiguous port components among the T2 largest second port components; or
the N1 first port components include equally spaced port components among the T1 largest first port components; or
the N2 second port components include equally spaced port components among the T2 largest second port components; or
the N1 first port components include a plurality of equally spaced groups of first port components among the T1 largest first port components, where each group of first port components includes a plurality of contiguous port components; or
the N2 second port components include a plurality of equally spaced groups of second port components among the T2 largest second port components, where each group of second port components includes a plurality of contiguous port components.

In some embodiments of this application, N1 and N2 are selected from one or more pairs of candidate values of N1 and N2.

In some embodiments of this application, P1 is selected from one or more candidate values of P1; or
the P CSI reference signal ports correspond to one or more port subsets, and the P1 CSI reference signal ports correspond to one of the one or more port subsets.

In some embodiments of this application, the configuration information includes configuration information of L codebook basis vectors, L being a positive integer, and the feedback module 1320 is configured to:
select, from the L codebook basis vectors, L1 codebook basis vectors for CSI feedback, where the CSI fed back includes information related to the selected codebook basis vectors, and L1 is a positive integer, where
the at least one of the at least two submatrices includes one or more codebook basis vectors, and a quantity of the codebook basis vectors is determined based on L1.

In some embodiments of this application, the precoding matrix or part of the precoding matrix is determined based on a product of a matrix formed by the L codebook basis vectors and a second matrix, and the second matrix is used to indicate a selection manner for selecting the L1 codebook basis vectors from the L codebook basis vectors.

In some embodiments of this application, the codebook basis vector indicates spatial domain information or frequency domain information or time domain information of a channel.

In some embodiments of this application, the configuration information includes configuration information of S resource units, S being a positive integer, and the feedback module 1320 is configured to:
select, from the S resource units, S1 resource units for CSI feedback, where the CSI fed back includes information related to the selected resource units, and S1 is a positive integer, where
the at least one of the at least two submatrices includes one or more codebook basis vectors, and a length of each codebook basis vector is determined based on S1.

In some embodiments of this application, the resource unit includes at least one of a frequency domain resource unit and a time domain resource unit, where
the frequency domain resource unit includes at least one of the following:
a subband, a resource block, a subband group, a resource block group, part of a subband, a subcarrier, a frequency band, and a bandwidth part; or
the time domain resource unit includes at least one of the following:
a slot, a slot group, an orthogonal frequency division multiplexing symbol, an orthogonal frequency division multiplexing symbol group, a Doppler domain unit, a Doppler domain unit group, and part of a Doppler domain unit.

In some embodiments of this application, the S1 resource units are Type I resource units, and resource units other than the S1 resource units among the S resource units are Type II resource units, where
the Type I resource units are contiguous resource units among the S resource units; or
the Type I resource units are equally spaced resource units among the S resource units; or
the Type I resource units are a plurality of equally spaced groups of resource units among the S resource units, where each group of resource units includes a plurality of contiguous resource units; or
at least one codebook parameter associated with the Type I resource units is different from at least one codebook parameter associated with the Type II resource units; or
a value of at least one codebook parameter associated with the Type I resource units is greater than or equal to a value of at least one codebook parameter associated with the Type II resource units.

In some embodiments of this application, information related to the resource units includes switching information between the Type I resource units and the Type II resource units.

In some embodiments of this application, the codebook parameter includes at least one of the following:
a quantity of codebook basis vectors; and
a quantity of quantization states of coefficients.

In some embodiments of this application, the codebook basis vector is a discrete Fourier transform vector or a Kronecker product of discrete Fourier transform vectors.

The CSI feedback apparatus 1300 in this embodiment of this application may be an electronic device, for example, an electronic device with an operating system, or may be a component in an electronic device, for example, an integrated circuit or a chip. The electronic device may be a terminal, or may be other devices than a terminal. For example, the terminal may include but is not limited to the foregoing illustrated type of the terminal 11. The other devices may be a server, a Network Attached Storage (NAS), and the like. This is not specifically limited in this embodiment of this application.

The CSI feedback apparatus 1300 provided in this embodiment of this application can implement each process implemented in the method embodiment in FIG. 2 to FIG. 11, with the same technical effect achieved. To avoid repetition, details are not described herein again.

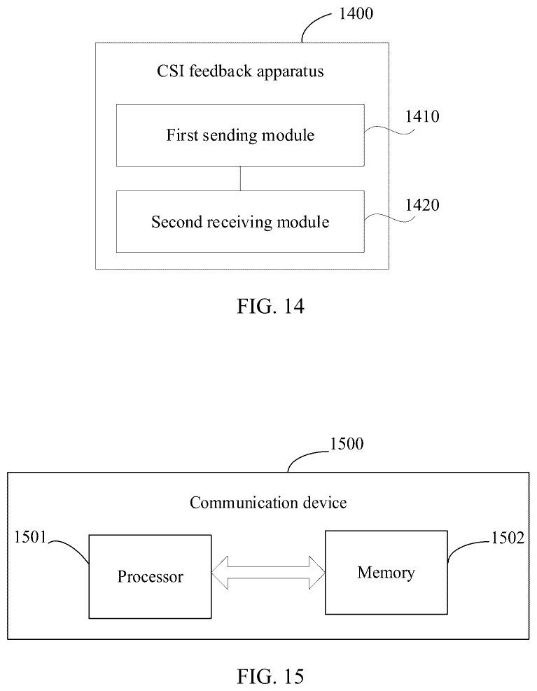

As shown in FIG. 14, a CSI feedback apparatus 1400 may include the following modules:
a first sending module 1410, configured to send configuration information for channel state information CSI to a terminal, where part or all of information associated with the configuration information is selected for CSI feedback; and
a second receiving module 1420, configured to receive the CSI fed back by the terminal, the CSI fed back including information related to the selected information, where
a precoding matrix indicated by the CSI fed back is a product of at least two submatrices, and a dimension of at least one of the at least two submatrices is determined based on the selected information.

In this embodiment of this application, the apparatus sends the configuration information for the CSI to the terminal, and the terminal selects, from the information associated with the configuration information, part or all of the information for CSI feedback. The CSI fed back includes the information related to the selected information. The precoding matrix indicated by the CSI fed back is the product of the at least two submatrices, and the dimension of the at least one of the at least two submatrices is determined based on the selected information. Instead of merely relying on the configuration of the network-side device for CSI feedback, the terminal-side selection is added. In this way, CSI feedback with different precision can be performed in real time to adapt to channel changes, and a loss in CSI feedback accuracy or CSI feedback robustness can be effectively prevented.

In some embodiments of this application, the configuration information includes configuration information of P CSI reference signal ports, where P is a positive integer;
that part or all of information associated with the configuration information is selected for CSI feedback includes: P1 CSI reference signal ports among the P CSI reference signal ports are selected for CSI feedback, where P1 is a positive integer; and
the information related to the selected information includes information related to the selected CSI reference signal ports, where
the at least one of the at least two submatrices includes one or more codebook basis vectors, and a length of each codebook basis vector is determined based on P1.

In some embodiments of this application, the length of each codebook basis vector is P1/M1, and M1 is a positive integer.

In some embodiments of this application, the precoding matrix or part of the precoding matrix is determined based on a product of a matrix formed by the one or more codebook basis vectors and a first matrix, and the first matrix is used to indicate a selection manner for selecting the P1 CSI reference signal ports from the P CSI reference signal ports.

In some embodiments of this application, the P1 CSI reference signal ports include contiguous ports among the P CSI reference signal ports; or
the P1 CSI reference signal ports include equally spaced ports among the P CSI reference signal ports; or
the P1 CSI reference signal ports include a plurality of equally spaced groups of ports among the P CSI reference signal ports, where each group of ports includes a plurality of contiguous ports.

In some embodiments of this application, the information related to the CSI reference signal ports includes at least one of the following:
information corresponding to the P1 CSI reference signal ports among the P CSI reference signal ports;
information corresponding to P1/K1 CSI reference signal ports among P/K1 CSI reference signal ports, where K1 is a positive integer;
N port components included in the P1 CSI reference signal ports, where N is a positive integer;
information corresponding to N port components included in the P1 CSI reference signal ports among the P CSI reference signal ports;
information corresponding to N port components included in the P1 CSI reference signal ports among the P1 CSI reference signal ports; and
information corresponding to N port components included in the P1 CSI reference signal ports, among T largest port components corresponding to the P CSI reference signal ports, where T is a positive integer.

In some embodiments of this application, the N port components include N1 first port components and N2 second port components, where a product of N1 and N2 is equal to P1 or P1/M2, and N1, N2, and M2 are positive integers; and
the T largest port components include T1 largest first port components or T2 largest second port components, where a product of T1 and T2 is equal to P or P/M3, and T1, T2, and M3 are positive integers.

In some embodiments of this application, the information corresponding to the N port components included in the P1 CSI reference signal ports, among the T largest port components corresponding to the P CSI reference signal ports, includes at least one of the following:
information corresponding to the N1 first port components among the T1 largest first port components;
information corresponding to the N2 second port components among the T2 largest second port components;
a ratio of N1 to T1;
a ratio of N2 to T2;
a start number or an end number of the N1 first port components;
a start number or an end number of the N2 second port components;
a numbering interval between every two adjacent port components among the N1 first port components; and
a numbering interval between every two adjacent port components among the N2 second port components.

In some embodiments of this application, a ratio of N1 to N2 is equal to a ratio of T1 to T2.

In some embodiments of this application, the N1 first port components include contiguous port components among the T1 largest first port components; or
the N2 second port components include contiguous port components among the T2 largest second port components; or
the N1 first port components include equally spaced port components among the T1 largest first port components; or
the N2 second port components include equally spaced port components among the T2 largest second port components; or
the N1 first port components include a plurality of equally spaced groups of first port components among the T1 largest first port components, where each group of first port components includes a plurality of contiguous port components; or
the N2 second port components include a plurality of equally spaced groups of second port components among the T2 largest second port components, where each group of second port components includes a plurality of contiguous port components.

In some embodiments of this application, the configuration information of the P CSI reference signal ports includes information on one or more pairs of candidate values of N1 and N2.

In some embodiments of this application, the configuration information of the P CSI reference signal ports includes at least one of the following:
information on one or more candidate values of P1; and
information on one or more port subsets corresponding to the P CSI reference signal ports.

In some embodiments of this application, the configuration information includes configuration information of L codebook basis vectors, where L is a positive integer;
that part or all of information associated with the configuration information is selected for CSI feedback includes: L1 codebook basis vectors among the L codebook basis vectors are selected for CSI feedback, where L1 is a positive integer; and
the information related to the selected information includes information related to the selected codebook basis vectors, where
the at least one of the at least two submatrices includes one or more codebook basis vectors, and a quantity of the codebook basis vectors is determined based on L1.

In some embodiments of this application, the precoding matrix or part of the precoding matrix is determined based on a product of a matrix formed by the L codebook basis vectors and a second matrix, and the second matrix is used to indicate a selection manner for selecting the L1 codebook basis vectors from the L codebook basis vectors.

In some embodiments of this application, the codebook basis vector indicates spatial domain information or frequency domain information or time domain information of a channel.

In some embodiments of this application, the configuration information includes configuration information of S resource units, where S is a positive integer;
that part or all of information associated with the configuration information is selected for CSI feedback includes: S1 resource units among the S resource units are selected for CSI feedback, where S1 is a positive integer; and
the information related to the selected information includes information related to the selected resource units, where
the at least one of the at least two submatrices includes one or more codebook basis vectors, and a length of each codebook basis vector is determined based on S1.

In some embodiments of this application, the resource unit includes at least one of a frequency domain resource unit and a time domain resource unit, where
the frequency domain resource unit includes at least one of the following:
a subband, a resource block, a subband group, a resource block group, part of a subband, a subcarrier, a frequency band, and a bandwidth part; or
the time domain resource unit includes at least one of the following:
a slot, a slot group, an orthogonal frequency division multiplexing symbol, an orthogonal frequency division multiplexing symbol group, a Doppler domain unit, a Doppler domain unit group, and part of a Doppler domain unit.

In some embodiments of this application, the S1 resource units are Type I resource units, and resource units other than the S1 resource units among the S resource units are Type II resource units, where
the Type I resource units are contiguous resource units among the S resource units; or
the Type I resource units are equally spaced resource units among the S resource units; or
the Type I resource units are a plurality of equally spaced groups of resource units among the S resource units, where each group of resource units includes a plurality of contiguous resource units; or
at least one codebook parameter associated with the Type I resource units is different from at least one codebook parameter associated with the Type II resource units; or
a value of at least one codebook parameter associated with the Type I resource units is greater than or equal to a value of at least one codebook parameter associated with the Type II resource units.

In some embodiments of this application, information related to the resource units includes switching information between the Type I resource units and the Type II resource units.

In some embodiments of this application, the codebook parameter includes at least one of the following:
a quantity of codebook basis vectors; and
a quantity of quantization states of coefficients.

In some embodiments of this application, the codebook basis vector is a discrete Fourier transform vector or a Kronecker product of discrete Fourier transform vectors.

The CSI feedback apparatus 1400 provided in this embodiment of this application can implement each process implemented in the method embodiment shown in FIG. 3 to FIG. 12, with the same technical effect achieved. To avoid repetition, details are not described herein again.

As shown in FIG. 15, an embodiment of this application further provides a communication device 1500, including a processor 1501 and a memory 1502. The memory 1502 stores a program or instructions capable of running on the processor 1501. For example, when the communication device 1500 is a terminal, and the program or instructions are executed by the processor 1501, the steps of the foregoing method embodiments shown in FIG. 2 to FIG. 11 are implemented, with the same technical effect achieved. When the communication device 1500 is a network-side device, and the program or instructions are executed by the processor 1501, the steps of the foregoing method embodiments shown in FIG. 3 to FIG. 12 are implemented, with the same technical effect achieved. To avoid repetition, details are not described herein again.

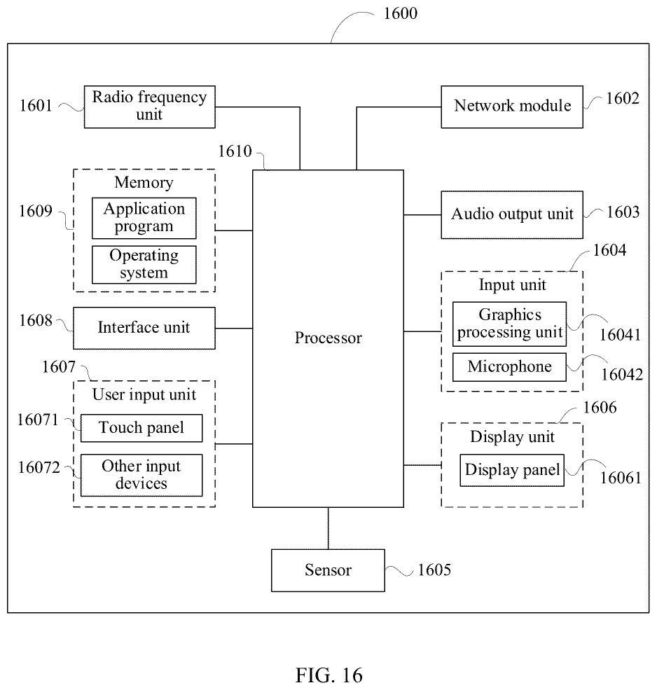

An embodiment of this application further provides a terminal, including a processor and a communication interface. The communication interface is coupled to the processor. The processor is configured to run a program or instructions to implement the steps of the method embodiments shown in FIG. 2 to FIG. 11. The terminal embodiment corresponds to the foregoing terminal-side method embodiment, and each implementation process and implementation of the foregoing method embodiment can be applied to the terminal embodiment, with the same technical effect achieved. Specifically, FIG. 16 is a schematic diagram of a hardware structure of a terminal for implementing an embodiment of this application.

The terminal 1600 includes but is not limited to at least some components such as a radio frequency unit 1601, a network module 1602, an audio output unit 1603, an input unit 1604, a sensor 1605, a display unit 1606, a user input unit 1607, an interface unit 1608, a memory 1609, and a processor 1610.

A person skilled in the art may understand that the terminal 1600 may further include a power supply (for example, a battery) supplying power to all components. The power supply may be logically connected to the processor 1610 through a power management system. In this way, functions such as charge management, discharge management, and power consumption management are implemented by using the power management system. The terminal structure shown in FIG. 16 does not constitute a limitation on the terminal. The terminal may include more or fewer components than those shown in the figure, or some components are combined, or component arrangements are different. Details are not described herein again.

It should be understood that, in this embodiment of this application, the input unit 1604 may include a Graphics Processing Unit (GPU) 16041 and a microphone 16042. The graphics processing unit 16041 processes image data of a still picture or video obtained by an image capture apparatus (such as a camera) in a video capture mode or an image capture mode. The display unit 1606 may include a display panel 16061, and the display panel 16061 may be configured in a form of a liquid crystal display, an organic light-emitting diode, or the like. The user input unit 1607 includes at least one of a touch panel 16071 and other input devices 16072. The touch panel 16071 is also referred to as a touchscreen. The touch panel 16071 may include two parts: a touch detection apparatus and a touch controller. The other input devices 16072 may include but are not limited to a physical keyboard, a function button (such as a volume control button or a power button), a trackball, a mouse, and a joystick. Details are not described herein again.

In this embodiment of this application, after receiving downlink data from a network-side device, the radio frequency unit 1601 may transmit the downlink data to the processor 1610 for processing. In addition, the radio frequency unit 1601 may send uplink data to the network-side device. Usually, the radio frequency unit 1601 includes but is not limited to an antenna, an amplifier, a transceiver, a coupler, a low noise amplifier, a duplexer, and the like.

The memory 1609 may be configured to store software programs or instructions and various data. The memory 1609 may primarily include a first storage area for storing programs or instructions and a second storage area for storing data. The first storage area may store an operating system, an application program or instructions required by at least one function (such as an audio play function and an image play function), and the like. In addition, the memory 1609 may include a volatile memory or a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data rate SDRAM (DDR SDRAM), an Enhanced SDRAM (ESDRAM), a Synch link DRAM (SLDRAM), and a Direct Rambus RAM (DRRAM). The memory 1609 in this embodiment of this application includes but is not limited to these and any other suitable types of memories.

The processor 1610 may include one or more processing units. Optionally, the processor 1610 integrates an application processor and a modem processor. The application processor mainly processes operations related to the operating system, a user interface, an application program, and the like. The modem processor mainly processes a wireless communication signal. For example, the modem processor is a baseband processor. It may be understood that the modem processor may alternatively not be integrated in the processor 1610.

It may be understood that for the implementation process of each implementation in the embodiment, reference may be made to the related descriptions in the method embodiments shown in FIG. 2 to FIG. 11, with the same or corresponding technical effect achieved. To avoid repetition, details are not described herein again.

An embodiment of this application further provides a network-side device, including a processor and a communication interface. The communication interface is coupled to the processor. The processor is configured to run a program or instructions to implement the steps of the method embodiments shown in FIG. 3 to FIG. 12. The network-side device embodiment corresponds to the foregoing method embodiment on the network-side device, and each implementation process and implementation of the foregoing method embodiment can be applied to the network-side device embodiment, with the same technical effect achieved.

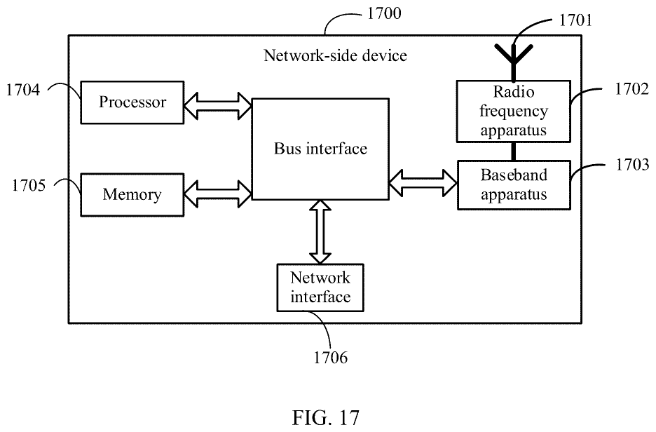

Specifically, an embodiment of this application further provides a network-side device. As shown in FIG. 17, the network-side device 1700 includes an antenna 1701, a radio frequency apparatus 1702, a baseband apparatus 1703, a processor 1704, and a memory 1705. The antenna 1701 is connected to the radio frequency apparatus 1702. In an uplink direction, the radio frequency apparatus 1702 receives information by using the antenna 1701, and sends the received information to the baseband apparatus 1703 for processing. In a downlink direction, the baseband apparatus 1703 processes to-be-sent information, and sends the information to the radio frequency apparatus 1702; and the radio frequency apparatus 1702 processes the received information and then sends the information out by using the antenna 1701.

The method performed by the network-side device in the foregoing embodiment may be implemented in the baseband apparatus 1703. The baseband apparatus 1703 includes a baseband processor.

The baseband apparatus 1703 may include, for example, at least one baseband unit. A plurality of chips are disposed on the baseband unit. As shown in FIG. 17, one of the chips is, for example, the baseband processor, connected to the memory 1705 by using a bus interface, to invoke a program in the memory 1705 to perform operations of the network-side device shown in the foregoing method embodiment.

The network-side device may further include a network interface 1706, where the interface is, for example, a Common Public Radio (CPRI).

Specifically, the network-side device 1700 in this embodiment of the present invention further includes a program or instructions stored in the memory 1705 and capable of running on the processor 1704. When the processor 1704 invokes the program or instructions in the memory 1705, the method performed by each module shown in FIG. 14 is performed, with the same technical effect achieved. To avoid repetition, details are not described herein again.

An embodiment of this application further provides a readable storage medium. The readable storage medium stores a program or instructions. When the program or instructions are executed by a processor, each process of the foregoing method embodiments shown in FIG. 2 to FIG. 11 is implemented, or each process of the foregoing method embodiments shown in FIG. 3 to FIG. 12 is implemented, with the same technical effect achieved. To avoid repetition, details are not described herein again.

The processor is a processor in the terminal in the foregoing embodiment. The readable storage medium includes a computer-readable storage medium, such as a computer read-only memory ROM, a random access memory RAM, a magnetic disk, or an optical disc. In some examples, the readable storage medium may be a non-transitory readable storage medium.

In addition, an embodiment of this application provides a chip. The chip includes a processor and a communication interface. The communication interface is coupled to the processor. The processor is configured to run a program or instructions to implement each process of the foregoing method embodiments shown in FIG. 2 to FIG. 11 or implement each process of the foregoing method embodiments shown in FIG. 3 to FIG. 12, with the same technical effect achieved. To avoid repetition, details are not described herein again.

It should be understood that the chip provided in this embodiment of this application may also be referred to as a system-level chip, a system chip, a chip system, a system-on-chip, or the like.

In addition, an embodiment of this application provides a computer program or program product. The computer program or program product is stored in a storage medium. The computer program or program product is executed by at least one processor to implement each process of the foregoing method embodiments shown in FIG. 2 to FIG. 11 or implement each process of the foregoing method embodiments shown in FIG. 3 to FIG. 12, with the same technical effect achieved. To avoid repetition, details are not described herein again.

An embodiment of this application further provides a wireless communication system, including a terminal and a network-side device. The terminal may be configured to perform the steps of the foregoing method shown in FIG. 2 to FIG. 11. The network-side device may be configured to perform the steps of the foregoing method shown in FIG. 3 to FIG. 12.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

Based on the foregoing descriptions of the implementations, a person skilled in the art may clearly understand that the foregoing embodiment methods can be implemented by using a computer software product in combination with a necessary general hardware platform, or by using hardware only. The computer software product is stored in a storage medium (such as a ROM, a RAM, a magnetic disk, or an optical disc), and includes several instructions for instructing a terminal or a network-side device to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners of embodiments without departing from principles of this application and the protection scope of the claims, and all such manners of embodiments fall within the protection scope of this application.

What is claimed is:

1. A CSI feedback method, comprising:
receiving, by a terminal, from a network-side device, configuration information for channel state information CSI; and
selecting, by the terminal, from information associated with the configuration information, part or all of the information for CSI feedback, the CSI fed back comprising information related to the selected information, wherein
a precoding matrix indicated by the CSI fed back is a product of at least two submatrices, and a dimension of at least one of the at least two submatrices is determined based on the selected information.

2. The method according to claim 1, wherein the configuration information comprises configuration information of P CSI reference signal ports, P being a positive integer, and the selecting, by the terminal, from information associated with the configuration information, part or all of the information for CSI feedback, the CSI fed back comprising information related to the selected information, comprises:
selecting, by the terminal, from the P CSI reference signal ports, P1 CSI reference signal ports for CSI feedback, wherein the CSI fed back comprises information related to the selected CSI reference signal ports, and P1 is a positive integer, wherein the at least one of the at least two submatrices comprises one or more codebook basis vectors, and a length of each codebook basis vector is determined based on P1.

3. The method according to claim 2, wherein the length of each codebook basis vector is P1/M1, and M1 is a positive integer.

4. The method according to claim 2, wherein the precoding matrix or part of the precoding matrix is determined based on a product of a matrix formed by the one or more codebook basis vectors and a first matrix, and the first matrix is used to indicate a selection manner for selecting the P1 CSI reference signal ports from the P CSI reference signal ports.

5. The method according to claim 2, wherein the P1 CSI reference signal ports comprise contiguous ports among the P CSI reference signal ports; or
the P1 CSI reference signal ports comprise equally spaced ports among the P CSI reference signal ports; or
the P1 CSI reference signal ports comprise a plurality of equally spaced groups of ports among the P CSI reference signal ports, wherein each group of ports comprises a plurality of contiguous ports.

6. The method according to claim 2, wherein the information related to the CSI reference signal ports comprises at least one of the following:
information corresponding to the P1 CSI reference signal ports among the P CSI reference signal ports;
information corresponding to P1/K1 CSI reference signal ports among P/K1 CSI reference signal ports, wherein K1 is a positive integer;
N port components comprised in the P1 CSI reference signal ports, wherein N is a positive integer;
information corresponding to N port components comprised in the P1 CSI reference signal ports among the P CSI reference signal ports;
information corresponding to N port components comprised in the P1 CSI reference signal ports among the P1 CSI reference signal ports; or
information corresponding to N port components comprised in the P1 CSI reference signal ports, among T largest port components corresponding to the P CSI reference signal ports, wherein T is a positive integer.

7. The method according to claim 6, wherein the N port components comprise N1 first port components and N2 second port components, wherein a product of N1 and N2 is equal to P1 or P1/M2, and N1, N2, and M2 are positive integers; and
the T largest port components comprise T1 largest first port components or T2 largest second port components, wherein a product of T1 and T2 is equal to Por P/M3, and T1, T2, and M3 are positive integers.

8. The method according to claim 7, wherein the information corresponding to the N port components comprised in the P1 CSI reference signal ports, among the T largest port components corresponding to the P CSI reference signal ports, comprises at least one of the following:
information corresponding to the N1 first port components among the T1 largest first port components;
information corresponding to the N2 second port components among the T2 largest second port components;
a ratio of N1 to T1;
a ratio of N2 to T2;
a start number or an end number of the N1 first port components;
a start number or an end number of the N2 second port components;
a numbering interval between every two adjacent port components among the N1 first port components; or
a numbering interval between every two adjacent port components among the N2 second port components.

9. The method according to claim 7, wherein a ratio of N1 to N2 is equal to a ratio of T1 to T2.

10. The method according to claim 7, wherein the N1 first port components comprise contiguous port components among the T1 largest first port components; or
the N2 second port components comprise contiguous port components among the T2 largest second port components; or
the N1 first port components comprise equally spaced port components among the T1 largest first port components; or
the N2 second port components comprise equally spaced port components among the T2 largest second port components; or
the N1 first port components comprise a plurality of equally spaced groups of first port components among the T1 largest first port components, wherein each group of first port components comprises a plurality of contiguous port components; or
the N2 second port components comprise a plurality of equally spaced groups of second port components among the T2 largest second port components, wherein each group of second port components comprises a plurality of contiguous port components.

11. The method according to claim 7, wherein N1 and N2 are selected from one or more pairs of candidate values of N1 and N2.

12. The method according to claim 2, wherein P1 is selected from one or more candidate values of P1; or
the P CSI reference signal ports correspond to one or more port subsets, and the P1 CSI reference signal ports correspond to one of the one or more port subsets.

13. The method according to claim 1, wherein the configuration information comprises configuration information of L codebook basis vectors, L being a positive integer, and the selecting, by the terminal, from information associated with the configuration information, part or all of the information for CSI feedback, the CSI fed back comprising information related to the selected information, comprises:
selecting, by the terminal, from the L codebook basis vectors, L1 codebook basis vectors for CSI feedback, wherein the CSI fed back comprises information related to the selected codebook basis vectors, and L1 is a positive integer, wherein
the at least one of the at least two submatrices comprises one or more codebook basis vectors, and a quantity of the codebook basis vectors is determined based on L1.

14. The method according to claim 13, wherein the precoding matrix or part of the precoding matrix is determined based on a product of a matrix formed by the L codebook basis vectors and a second matrix, and the second matrix is used to indicate a selection manner for selecting the L1 codebook basis vectors from the L codebook basis vectors.

15. The method according to claim 13, wherein the codebook basis vector indicates spatial domain information or frequency domain information or time domain information of a channel.

16. The method according to claim 1, wherein the configuration information comprises configuration information of S resource units, S being a positive integer, and the selecting, by the terminal, from information associated with the configuration information, part or all of the information for CSI feedback, the CSI fed back comprising information related to the selected information, comprises:
selecting, by the terminal, from the S resource units, S1 resource units for CSI feedback, wherein the CSI fed back comprises information related to the selected resource units, and S1 is a positive integer, wherein
the at least one of the at least two submatrices comprises one or more codebook basis vectors, and a length of each codebook basis vector is determined based on S1.

17. The method according to claim 16, wherein the resource unit comprises at least one of a frequency domain resource unit and a time domain resource unit.

18. A CSI feedback method, comprising:
sending, by a network-side device, configuration information for channel state information CSI to a terminal, wherein part or all of information associated with the configuration information is selected for CSI feedback; and
receiving, by the network-side device, the CSI fed back by the terminal, the CSI fed back comprising information related to the selected information, wherein
a precoding matrix indicated by the CSI fed back is a product of at least two submatrices, and a dimension of at least one of the at least two submatrices is determined based on the selected information.

19. A terminal, comprising a processor and a memory, wherein the memory stores a program or instructions capable of running on the processor, and when the program or instructions are executed by the processor, a CSI feedback method is implemented, the CSI feedback method comprising:
receiving from a network-side device, configuration information for channel state information CSI; and
selecting from information associated with the configuration information, part or all of the information for CSI feedback, the CSI fed back comprising information related to the selected information, wherein
a precoding matrix indicated by the CSI fed back is a product of at least two submatrices, and a dimension of at least one of the at least two submatrices is determined based on the selected information.

20. A network-side device, comprising a processor and a memory, wherein the memory stores a program or instructions capable of running on the processor, and when the program or instructions are executed by the processor, the steps of the CSI feedback method according to claim 18 are implemented.
